(19) United States
(12) Patent Application Publication
(10) Pub. No.: US 2012/0115065 A1
(43) Pub. Date: May 10, 2012

(54) ION-CONDUCTIVE COMPOSITE ELECTROLYTE, MEMBRANE-ELECTRODE ASSEMBLY USING THE SAME, ELECTROCHEMICAL DEVICE USING MEMBRANE-ELECTRODE ASSEMBLY, AND METHOD FOR PRODUCING ION-CONDUCTIVE COMPOSITE ELECTROLYTE MEMBRANE

(75) Inventors: Takuro Hirakimoto, Kanagawa (JP); Kazuaki Fukushima, Kanagawa (JP); Kenji Kishimoto, Tokyo (JP)

(73) Assignee: SONY CORPORATION, Tokyo (JP)

(21) Appl. No.: 13/384,146

(22) PCT Filed: Jul. 16, 2010
(86) PCT No.: PCT/JP2010/062482

§ 371 Date: Jan. 13, 2012

(30) Foreign Application Priority Data
Jul. 22, 2009 (JP) 2009-170930

(51) Int. Cl. H01M 8/10; B05D 5/12; B82Y 99/00

(52) U.S. Cl. 429/483; 429/493; 427/115; 977/948; 977/737

(57) ABSTRACT

Provided are an ion-conductive composite electrolyte that improves ionic conductivity, a membrane-electrode assembly and an electrochemical device using the same, and a method for producing an ion-conductive composite electrolyte membrane.

A proton-conductive composite electrolyte contains an electrolyte having a proton-dissociative group (—SO₃H) and a compound having a Lewis acid group MXₙ₋₁, wherein the Lewis acid group and the proton-dissociative group interact with each other. The compound having the Lewis acid group is a Lewis acid compound MXₙ or a polymer having a Lewis acid group MXₙ₋₁. The electrolyte having a proton-dissociative group is, for example, a fullerene derivative. A proton-conductive composite electrolyte membrane is formed using a solvent having a donor number of 25 or less, and a membrane-electrode assembly using the same is suitable for use in a fuel cell.

### TECHNICAL FIELD

The present invention relates to an ion-conductive composite electrolyte, a membrane-electrode assembly using the same, an electrochemical device, such as a fuel cell, using a membrane-electrode assembly, and a method for producing an ion-conductive composite electrolyte membrane.

### BACKGROUND ART

Fuel cells, which are electrochemical devices that convert chemical energy into electrical energy, have a high efficiency and do not generate environmental pollutants during the energy conversion. Thus, fuel cells have been attracting attention as a clean power supply for mobile information devices, households, automobiles, and the like, and the development thereof has been advanced.

Fuel cells are classified into a phosphoric acid-type fuel cell (PAFC), a molten carbonate-type fuel cell (MCFC), a solid oxide-type fuel cell (SOFC), a polymer electrolyte-type fuel cell (PEFC), an alkaline-type fuel cell (AFC), and the like in accordance with the type of electrolyte used. These fuel cells differ from each other in the type of fuel used, the operating temperature, the catalyst, the electrolyte, etc. Among these, since the PEFC can achieve a low-temperature operation, a high-output density, rapid driving and output response, etc., the PEFC is believed to be promising not only for small-scale stationary power-generating devices but also power-generating devices used in a transport system such as an automobile.

A membrane-electrode assembly (MEA) which is a main part of the PEFC usually includes a polymer electrolyte membrane obtained by processing a polymer electrolyte into a membranous form, and two electrodes (catalyst electrodes) provided on both surfaces of the polymer electrolyte membrane and respectively functioning as a cathode and an anode.

The polymer electrolyte membrane has a function of a proton conductor, and further has a function of a separation membrane for preventing a direct contact between an oxidizing agent and a reducing agent and a function of electrically insulating the two electrodes. For the polymer electrolyte membrane, conditions such as (1) high proton conductivity, (2) a high electrical insulating property, (3) a low permeability to reactants and reaction products in a fuel cell, (4) satisfactory thermal, chemical, and mechanical stability under the operating conditions of a fuel cell, and (5) a low cost are required.

Heretofore, various types of polymer electrolytes have been developed. It is believed that an electrolyte composed of a perfluorosulfonic acid-based resin is excellent in terms of durability and performance.

In the case of a direct methanol fuel cell (DMFC), an aqueous methanol solution is supplied as a fuel to the anode. However, a part of the unreacted aqueous methanol solution permeates through a polymer electrolyte membrane, and this permeated aqueous methanol solution spreads over the electrolyte membrane and reaches a cathode catalyst layer. This phenomenon is called “methanol crossover”. By the methanol crossover, direct oxidation of methanol is caused in the cathode where an electrochemical reduction reaction between hydrogen ions (protons) and oxygen should occur. Consequently, the cathode potential is decreased, which may cause a decrease in the performance of the fuel cell. This problem is common to not only fuel cells in which methanol is used but also fuel cells in which other organic fuels are used.

An important task to realize practical application and the widespread use of fuel cells is to extend the lifetime of the fuel cells by, for example, suppressing degradation of materials of electrodes, a noble metal catalyst, an electrolyte membrane, and the like in long-term operation; suppressing the influence of water produced by an electrochemical reaction; suppressing a loss of a fuel caused by the permeation of fuel molecules through the electrolyte membrane and subsequent crossover between the electrodes; suppressing the generation of hydrogen peroxide; suppressing the generation of radicals derived from hydrogen peroxide; and suppressing the influence of the radicals. For this purpose, the development of a catalyst material that has a high reaction activity and that is not easily degraded and an electrolyte membrane having a low permeability of fuel molecules and a good proton-conducting property has been desired.

Various methods have been reported regarding the improvement of the proton-conducting property of an electrolyte and the suppression of crossover between electrodes.

First, PTL 1 below titled “Ion-conductive membrane and fuel cell using the same” includes the following description.

The invention of PTL 1 provides an ion-conductive membrane composed of a composite material of an ion-conductive polymer and a nitrogen-containing compound, in which the nitrogen-containing compound has an immobilization site to the ion-conductive polymer and has a tautomeric structure when being protonated. Thus, there is provided an ion-conductive membrane that can suppress crossover of methanol while maintaining an ion-conducting property.

In addition, PTL 2 below titled “Ion-conductive membrane, method for producing the same, and electrochemical device” includes the following description.

An object of the invention of PTL 2 is to provide an ion conductor that is insoluble in water and fuels and that can perform stable conduction of ions such as protons, a method for producing the same, and an electrochemical device.

The invention of PTL 2 relates to an ion conductor including a derivative in which an ion-dissociative group is bonded to a carbon substance composed of at least one selected from the group consisting of a fullerene molecule, a cluster containing carbon as a main component, and a structure of a linear or cylindrical carbon; and a polymer of a substance having a basic group.

In addition, PTL 3 below titled “Electrode, composition for electrode, fuel cell using the same, and method for producing electrode” includes the following description.

The electrode according to the invention of PTL 3 is characterized by containing catalyst particles in which catalytic metal particles composed of platinum or an alloy thereof are carried on the surface of a catalyst carrier containing SiO₂ as a main component; electrically conductive particles; and a proton-conductive substance. PTL 3 describes that the catalyst carrier is preferably SiO₂ alone, or a compound oxide that contains 50% by weight or more of a SiO₂ component and that exhibits Lewis acidity.

In addition, PTL 4 below titled “Proton conductor, catalyst electrode, assembly of catalyst electrode and proton conductor, fuel cell, and method for producing proton conductor” includes the following description.

According to an embodiment of the invention of PTL 4, there is provided a proton conductor including an organic proton-conductive polymer; and an inorganic proton conductive material obtained by condensation of an inorganic solid acid, and total 450 to 20,000 parts by mole of a Lewis acidic metal alkoxide and a silicon oxide precursor relative to 100 parts by mole of the inorganic solid acid, in which molecular chains of the organic proton-conductive polymer and molecular chains of the inorganic proton conductive material intrude each other to form a network structure.

By forming the network structure by the mutual intrusion of molecular chains of the organic proton-conductive polymer and molecular chains of the inorganic proton conductive material, swelling with water, methanol, or the like can be suppressed to realize a high dimensional stability, and in addition, a proton conductor having flexibility can be obtained.

In addition, PTL 5 below titled “Electrode material for fuel cell and fuel cell” includes the following description.

In an electrode material for a fuel cell according to the invention of PTL 5, an electrode for a fuel cell is provided on a front surface and/or a back surface of an electrolyte membrane, and the electrode material contains catalyst particles formed by including noble metal particles containing Pt into a porous inorganic material, and a proton-conductive substance. According to this electrode material for a fuel cell, since the noble metal particles are included in the porous inorganic material, elution of Pt in the electrolyte membrane is prevented, and it is possible to suppress a decrease in the performance of the fuel cell caused by the elution of Pt in the electrolyte membrane.

Note that, in the electrode material for a fuel cell according to the invention of PTL 5, materials containing, as a main component, any of SiO₂, ZrO₂, and TiO₂ can be exemplified as the porous inorganic material. Furthermore, the porous inorganic material preferably has a proton-conducting property so as to function as an electrode for a fuel cell. In such a case, a higher proton-conducting property can be provided to the porous inorganic material by using a material that exhibits Lewis acidity (electron-pair acceptor) as the porous inorganic material.

In addition, PTL 6 below titled “Proton-conductive substance” includes the following description.

An object of the invention of PTL 6 is to provide an electrolyte material having high proton conductivity and a simple method for producing the electrolyte material. In order to achieve high proton conductivity, in the invention of PTL 6, a borosiloxane backbone is focused as a structure that accelerates a dissociation property of sulfonic acid, and the preparation of a borosiloxane polymer by a hydrolysis-condensation method, which is an easy production method, and a method for sulfonating the polymer have been studied. As a result, an organic/inorganic hybrid-type proton conductor having high proton conductivity is obtained.

In the reaction mechanism 1 of the method for producing a proton-conductive substance of the invention of PTL 6, an alkoxysilane derivative having a thiol group and a boric acid ester are subjected to a hydrolysis reaction to produce a polymer, and by oxidizing the thiol group, a borosiloxane polymer having a sulfonic acid group is produced. Furthermore, in the reaction mechanism 2, an alkoxysilane derivative having a hydrocarbon group and a boric acid ester are subjected to a hydrolysis reaction to produce a polymer, and by sulfonating the hydrocarbon group, a borosiloxane polymer having a sulfonic acid group is produced. That is, the proton-conductive substance of the invention of PTL 6 can be produced by a hydrolysis-condensation reaction between an alkoxysilane derivative and a boric acid ester, followed by sulfonation. In this case, higher proton conductivity can be achieved by adopting appropriate reaction conditions.

According to the proton-conductive substance of the invention of PTL 6, dissociation of a sulfonic acid group is accelerated by the introduction of Lewis acidic boron, and thus the proton-conductive substance has high proton conductivity. By further doping phosphoric acid, the proton conductivity at high temperatures (about 100° C. to about 180° C., in particular about 100° C. to about 150° C.) can be increased.

In addition, PTL 7 below titled “Polymer solid electrolyte” includes the following description.

The invention of PTL 7 relates to a polymer solid electrolyte for a lithium secondary ion battery characterized in that a Lewis acid compound (such as boron trifluoride (BF₃) or a boroxine compound, or the like) is added to a composite material of a polyanion-type lithium salt and an ether-based polymer material, more preferably, the polymer solid electrolyte for a lithium secondary ion battery characterized in that the Lewis acid compound is BF₃. It is believed that BF₃ has a strong interaction with a carboxylate anion, and has an effect of improving the ion-conducting property.

Furthermore, PTL 8 below titled “Ion-conductive composition and method for producing the same” includes the following description.

An ion-conductive composition provided by the invention of PTL 8 contains a lithium salt represented by a general formula LiM(OY)ₙX₄₋ₙ (wherein n may be 1 to 3, M may be an element belonging to group XIII of the periodic table, Y may be an oligoether group, and X may be an electron-withdrawing group). This composition further contains an additive that can be coordinated to oxygen (i.e., that can be coordinately bonded to oxygen). For example, the composition contains an additive capable of being coordinated to at least one oxygen atom that is adjacent to M (i.e., that is directly bonded to M) in the lithium salt. In a typical embodiment of the composition disclosed here, at least a part of the additive in the composition is coordinated to oxygen (preferably, mainly oxygen adjacent to M) contained in an anion of the lithium salt. In other words, in the composition, the additive and the lithium salt (more specifically, an anion constituting the lithium salt) form a coordination compound. Such a composition can have a higher degree of dissociation of the lithium salt than, for example, a composition that does not contain the above-mentioned additive. With this configuration, the composition can be a composition that exhibits better characteristics (such as ionic conductivity).

In a preferred embodiment of the composition disclosed here, the additive is a strong Lewis acid. Here, the phrase the additive is “a strong Lewis acid” means that, in the composition, the additive is bonded to oxygen more preferentially than to lithium ions, or bonding between lithium ions and the additive occurs in an equilibrium manner. In either case, the interaction between lithium ions and oxygen is weakened by incorporating the additive. Accordingly, the composition containing the additive can be a composition in which the degree of dissociation of a lithium salt is more effectively increased. Examples of the preferable additive in the invention of PTL 8 include boron halides such as boron trifluoride (BF₃).

Furthermore, PTL 9 below titled “Electrolyte membrane” includes the following description.

An object of the invention of PTL 9 is to provide an electrolyte membrane, in particular, a hydrocarbon-based electrolyte membrane for a solid polymer-type fuel cell, in which the proton-conducting property is improved, and a method for producing the electrolyte membrane. Another object thereof is to provide an electrolyte membrane, in particular, a hydrocarbon-based electrolyte membrane for a solid polymer-type fuel cell, in which a proton-conducting property is improved and degradation of an electrolyte can be suppressed or prevented, and a method for producing the electrolyte membrane. It is described that these objects are achieved by an electrolyte membrane obtained by dispersing an additive in an amount of 1% to 50% by mass relative to an electrolyte.

According to the invention of PTL 9, because of the presence of a specific amount of the additive in the electrolyte membrane, the proton-conducting property of the electrolyte membrane can be significantly improved even under the condition of a relatively high humidity. Therefore, even when a hydrocarbon-based electrolyte membrane is used as an electrolyte membrane for a fuel cell, in particular, for a hydrogen-oxygen-type fuel cell, a sufficient proton-conducting property can be achieved.

The additive according to the invention of PTL 9 is preferably a fullerene derivative, a metal oxide, or the like. For example, in the case where fullerenol is used as the additive, since fullerenol has an effect of improving the proton-conducting property, it is possible to obtain an electrolyte membrane that can achieve a significantly high proton-conducting property, as compared with existing electrolyte membranes, even under the condition of a relatively high humidity (for example, a relative humidity of 60% or more). Therefore, this additive may be useful in a hydrocarbon-based electrolyte membrane, which heretofore has had a problem of a low proton-conducting property.

The additive according to the invention of PTL 9 is preferably a fullerene derivative, a metal oxide, or the like as described above. The fullerene derivative is preferably fullerenol, and the metal oxide is preferably an alkoxysilane or a titanium alkoxide.

In addition, PTL 10 below titled “Fullerene-based electrolyte for fuel cell” includes the following description.

Proton-conductive fullerene substances are added to a polymer material by doping, mechanical mixing, or forming a covalent bond by a chemical reaction. A proton conductor thus prepared can be used as a polymer electrolyte membrane of a fuel cell that operates in a wide range of relative humidity and a wide range of temperature of the boiling point of water or higher. Examples of the preferable proton-conductive fullerene substance include polyhydroxylated fullerene, polysulfonated fullerene, and polyhydroxylated polysulfonated fullerene.

Furthermore, NPL 1 below describes preparation of a borosiloxane solid electrolyte obtained by, in a product obtained by hydrolysis-polycondensation of (3-mercaptopropyl)methoxysilane (HS(CH₂)₃Si(OCH)₃), triisopropyl borate (B(OCH(CH₃)₂)₃), and (n-hexyl)trimethoxysilane (CH₃(CH₂)₅Si(OCH)₃), oxidizing a thiol group (—SH) to convert to a sulfonic acid group (—SO₃H), and a composite film composed of this borosiloxane solid electrolyte and Nafion (registered trademark).

Furthermore, NPL 2 below describes preparation of a borosiloxane solid electrolyte obtained by, in a product obtained by hydrolysis-polycondensation of (3-mercaptopropyl)methoxysilane (HS(CH₂)₃Si(OCH)₃), triisopropyl borate (B(OCH(CH₃)₂)₃), and (n-hexyl)trimethoxysilane (CH₃(CH₂)₅Si(OCH)₃), oxidizing a thiol group (—SH) to convert to a sulfonic acid group (—SO₃H), and a composite film composed of this borosiloxane solid electrolyte and partially sulfonated poly(ether-sulfone) (SPES).

Note that NPL 3 below describes a method for introducing Lewis acidic boron into a side chain of an organic polymer.

Furthermore, PTL 11 below titled “Lewis acid catalyst carried on polymer” includes the following description.

First, there is provided a Lewis acid group-containing catalyst carried on a polymer, characterized in that a Lewis acid group represented by a general formula MXₙ (wherein M represents a polyvalent element, X represents an anionic group, and n represents an integer corresponding to the valence of M) is bonded and carried on a polymer film with an SO₃ or SO₄ group therebetween.

Secondly, there is provided the Lewis acid group-containing catalyst carried on a polymer, characterized in that a Lewis acid bonding group represented by a general formula —R₀-MXₙ (wherein M represents a polyvalent metal element, X represents an anionic group, n represents an integer corresponding to the valence of M, and R₀ represents an SO₃ or SO₄ group) is bonded and carried on a polymer chain with a spacer molecular chain therebetween.

Furthermore, PTL 12 below titled “Lewis acid catalyst immobilized on hydrophobic polymer” includes the following description.

(1) There is provided a Lewis acid group-containing catalyst immobilized on a hydrophobic polymer, characterized in that a metal Lewis acid group is bonded and carried on an aromatic ring of a hydrophobic polymer mainly composed of an aromatic polymer with an SO₃ group therebetween at a controlled carrying ratio. (2) There is provided the Lewis acid group-containing catalyst immobilized on a hydrophobic polymer according to (1), characterized in that the Lewis acid group is a rare-earth metal salt. (3) There is provided the Lewis acid group-containing catalyst immobilized on a hydrophobic polymer according to (2), characterized in that the Lewis acid group is a rare-earth metal triflate.

Note that, in a fuel cell, an electrolyte is used in the form of an electrolyte membrane (refer to PTL 13 to PTL 17 listed below). In the case where an electrolyte is dispersed or dissolved in a solvent and the solvent is then removed by vaporization, when the electrolyte forms a three-dimensional structure and comes to have a membranous form, an electrolyte membrane is formed without using a binding agent (binder). However, when the electrolyte does not form a three-dimensional structure and does not come to have a membranous form, an electrolyte membrane is formed as follows. A resin such as a fluorocarbon resin is used as a binding agent, and a liquid is prepared by dispersing or dissolving the binding agent and an electrolyte in a solvent. A coating membrane is formed using this liquid or a porous membrane is impregnated with this liquid, and the solvent is then removed by vaporization. Hitherto, in many cases, a basic solvent such as dimethyl sulfoxide, dimethylformamide, or N-methylpyrrolidone has been used as the solvent. Furthermore, the synthesis of a proton conductor polymer using C₆₀ fullerene is known (refer to PTL 13 and PTL 18 listed below).

### CITATION LIST

### Patent Literature

PTL 1: Japanese Unexamined Patent Application Publication No. 2002-105220 (paragraphs 0008 and 0054)
PTL 2: Japanese Unexamined Patent Application Publication No. 2005-322555 (paragraphs 0008 to 0009)
PTL 3: Japanese Unexamined Patent Application Publication No. 2002-246033 (paragraphs 0010 to 0011 and 0028 to 0029)
PTL 4: Japanese Unexamined Patent Application Publication No. 2005-25943 (paragraphs 0037 and 0046)
PTL 5: Japanese Unexamined Patent Application Publication No. 2007-5292 (paragraphs 0007 to 0008)
PTL 6: Japanese Unexamined Patent Application Publication No. 2002-184427 (paragraphs 0004, 0009, and 0022, and FIGS. 1 and 2)
PTL 7: Japanese Unexamined Patent Application Publication No. 2006-318674 (paragraphs 0011 to 0013)
PTL 8 Japanese Unexamined Patent Application Publication No. 2007-115527 (paragraphs 0004 to 0005)
PTL 9: Japanese Unexamined Patent Application Publication No. 2007-265959 (paragraphs 0014 to 0015, 0023, 0028 to 0029, and 0033 to 0034)
PTL 10: Japanese Unexamined Patent Application Publication (Translation of PCT Application) No. 2007-503707 (paragraphs 0008 to 0013)
PTL 11: Japanese Unexamined Patent Application Publication No. 2001-137710 (paragraphs 0008 to 0009)
PTL 12: Japanese Unexamined Patent Application Publication No. 2005-254115 (paragraph 0009)
PTL 13: Japanese Unexamined Patent Application Publication No. 2005-93417 (paragraphs 0056 to 0072)
PTL 14: Japanese Unexamined Patent Application Publication No. 2006-79944 (paragraphs 0017 to 0019, paragraphs 0028 to 0029, and paragraph 0034 to 0035)
PTL 15: Japanese Unexamined Patent Application Publication No. 2007-257882 (paragraphs 0009 to 0023)
PTL 16: Japanese Unexamined Patent Application Publication No. 2009-13377 (paragraphs 0031 to 0032)
PTL 17: Japanese Unexamined Patent Application Publication No. 2009-43674 (paragraphs 0028 to 0030)
PTL 18: Japanese Unexamined Patent Application Publication No. 2005-68124 (paragraphs 0087 to 0106)

### Non Patent Literature

NPL 1: H. Suzuki et al., “Proton conducting borosiloxane solid electrolytes and their composites with Nafion”, Fuel Cells, 2002, 2, No. 1, 46-51 (2 Experimental)
NPL 2: T. Fujinami et al., “Proton conducting borosiloxane-poly(ether-sulfone) composite electrolyte”, Electrochimica Acta 50 (2004) 627-631 (2 Experimental, 3 Results and discussion)
NPL 3: Y. Qin et al., “Well-defined Boron-Containing Polymeric Lewis Acids”, J. Am. Chem. Soc., Vol. 124, No. 43, 2002, 12672-12673 (Scheme 1)

### SUMMARY OF INVENTION

### Technical Problem

Electrolyte membranes used in PEFCs or the like have a wide variety of performances that should be satisfied. Specifically, a high proton-conducting property, a sufficient performance that blocks permeation (cross leak or crossover) of a fuel and oxygen, excellent mechanical strength and heat resistance, and excellent water resistance and chemical stability, and the like are required.

However, among proton conductor materials for a solid polymer electrolyte-type fuel cell that have been used to date, there is no single material that can be formed into a membrane capable of meeting all these requirements by itself, which has been a significant impediment in the development and widespread use of fuel cells. One of proton conductors that are widely used in PEFCs and the like is Nafion (trade name; a perfluorosulfonic acid resin manufactured by DuPont). This is a perfluorinated sulfonic acid-based polymeric resin, contains no unsaturated bonds and has a perfluorinated structure, and is thermally and chemically stable. However, in a dry atmosphere or at high temperatures, Nafion has a problem in that water that is occluded inside the resin and that is necessary for exhibiting the proton-conducting property is lost, and the proton conductivity tends to decrease. Furthermore, there is a problem that Nafion does not have a sufficient performance for blocking permeation (cross leak or crossover) of a fuel.

In the case where the fuel is hydrogen, in order to prevent hydrogen gas supplied to a fuel electrode from permeating into the oxygen electrode side, it is necessary to increase the thickness of the membrane. As a result, the membrane resistance increases, thereby causing a problem of decreasing the output of the cell.

In a perfluorosulfonic acid-based resin, a sulfonic acid group and water adsorbed around the sulfonic acid group form a cluster structure, and protons move using the water in the cluster as a channel, thereby exhibiting a proton-conducting property. Accordingly, in order that this resin exhibits a high proton-conducting property, it is necessary to retain a sufficient amount of water inside of the resin. However, in such a case, when the fuel is methanol, the methanol, which has a high hydrophilicity, is dissolved in the water inside the resin and easily permeates through the membrane.

Fullerene derivatives in which a proton-dissociative group, e.g., a sulfonic acid group, is introduced into a carbonaceous material such as fullerene are promising materials in the respect of having a proton-conducting capability even in a non-humidified state. Thus, the application of such fullerene derivatives to fuel cells has been studied. However, many fullerene derivatives into which a proton-dissociative group is introduced are water-soluble and have a property of being easily hydrolyzed.

It should be noted that, here, the “proton-dissociative group” means a functional group from which a hydrogen atom is ionized as a proton (H⁺) and can be removed, and is represented by a formula —XH wherein X is any atom or atomic group having a divalent bonding hand (hereinafter the same).

It is known that, in a fullerene derivative, the larger the number of proton-dissociative groups that are introduced into one fullerene molecule, the higher the proton-conducting property. However, the proton-dissociative groups are hydrophilic, and thus the larger the number of introduced proton-dissociative groups, the more easily the fullerene derivative is hydrated, and the higher the solubility of the fullerene derivative in water. When a water-soluble fullerene derivative is used as an electrolyte of a fuel cell, the electrolyte is eluted into water produced by an electrode reaction in the fuel cell, and is lost by the elution. Therefore, in order to use a fullerene derivative by itself as an electrolyte, it is necessary to use a fullerene derivative that has a high proton-conducting property and that is hardly soluble in water. Thus, there are so many restrictions in the material design and the material selection.

It is difficult to satisfy an improvement of the proton-conducting property of an electrolyte, and a suppression of methanol permeability of the electrolyte and insolubilization of the electrolyte at the same time. The suppression of swelling of the electrolyte and insolubilization of the electrolyte can be realized by using an interaction between a proton and a basic compound. However, the number of protons that contribute to the conduction decreases, resulting in a decrease in the proton-conducting property.

In order to develop a polymer electrolyte membrane in which the methanol crossover is suppressed and which has good ionic conductivity, various studies on electrolytes have been conducted. However, a polymer electrolyte membrane having a sufficient performance has not yet been obtained.

In the case where an electrolyte membrane is formed, in existing methods, the electrolyte membrane is formed as follows: In the case where an electrolyte is dispersed or dissolved in a solvent and the solvent is then removed by vaporization, when the electrolyte forms a three-dimensional structure and comes to have a membranous form, the electrolyte membrane is formed without using a binding agent. Alternatively, when the electrolyte does not come to have a membranous form, the electrolyte membrane is formed as follows. A resin such as a fluorocarbon resin is used as a binding agent, and a liquid is prepared by dispersing or dissolving the binding agent and an electrolyte in a solvent. A coating membrane is formed using this liquid or a porous membrane is impregnated with this liquid, and the solvent is then removed by vaporization. In these existing methods, a solvent such as an organic solvent is used. However, with some types of solvents, the solvent remains in the electrolyte membrane as a result of the interaction between the solvent and an ion-dissociative group, e.g., a proton-dissociative group, and the degree to which the solvent is removed by vaporization may become insufficient. The proton conductivity of the electrolyte membrane may be decreased by the interaction between the solvent and the proton-dissociative group.

As exemplified in (A) and (B) of FIG. 14 illustrating a problem in the related art, it is believed that this interaction is generated by, for example, a hydrogen bond between an organic solvent (N,N-dimethylformamide) (CH₃)₂NCHO and (A) a sulfonic acid group (—SO₃H) of an electrolyte or a bond based on an on-dipole interaction between an organic solvent (N,N-dimethylformamide) (CH₃)₂NCHO and (B) a chloride MCl of a metal (M), the chloride MCl being an electrolyte. This interaction is believed to be a cause of the remaining of the solvent in the electrolyte membrane. This interaction disturbs the proceeding of ionic dissociation of the electrolyte in the electrolyte membrane, and becomes a cause of a decrease in the ionic conductivity.

Basic solvents such as dimethyl sulfoxide, dimethylformamide, and N-methylpyrrolidone, which have been hitherto used in forming an electrolyte membrane, are difficult to be removed because these basic solvents interact with an ionic dissociation property, and thus the solvent remains in the formed electrolyte membrane, thereby blocking the ion conduction. Even if such an electrolyte membrane is applied to an electrochemical device, it is difficult to fabricate a high-performance device because of a low ionic conductivity of the electrolyte membrane.

The present invention has been made in order to solve the above problems, and it is an object of the present invention to provide an ion-conductive composite electrolyte in which the ionic conductivity can be improved, and a suppression of crossover of methanol or the like and insolubilization can also be realized in combination, a membrane-electrode assembly using the same, an electrochemical device, such as a fuel cell, using a membrane-electrode assembly, and a method for producing an ion-conductive composite electrolyte membrane.

### Solution to Problem

Specifically, the present invention relates to an ion-conductive composite electrolyte containing an electrolyte having an ion-dissociative group (for example, SO₃H in an embodiment described below), and a compound having a Lewis acid group (for example, MR₂ in an embodiment described below), wherein an electron-accepting atom constituting the Lewis acid group and an electron-donating atom constituting the ion-dissociative group are bonded to each other. Herein, the term “Lewis acid group” refers to a functional group that functions as a Lewis acid (hereinafter the same).

Furthermore, the present invention relates to a membrane-electrode assembly including an electrolyte membrane composed of the above ion-conductive composite electrolyte, and catalyst electrodes in which a catalyst metal is carried on an electrically conductive carrier, wherein the catalyst electrodes are arranged on both sides of the electrolyte membrane.

Furthermore, the present invention relates to an electrochemical device including the above membrane-electrode assembly, wherein the electrochemical device is configured so that an ion generated in one of the pair of catalyst electrodes arranged on both sides of the electrolyte membrane is moved to the other catalyst electrode by the electrolyte membrane.

Furthermore, the present invention relates to a method for producing an ion-conductive composite electrolyte membrane, including a first step of preparing a solution in which an ion-conductive composite electrolyte is dispersed and/or dissolved in a solvent having a donor number of 25 or less by adding the ion-conductive composite electrolyte to the solvent, a second step of applying the solution onto a base or impregnating a base with the solution, and a third step of removing the solution by vaporization subsequent to the second step.

### Advantageous Effects of Invention

According to the present invention, the ion-conductive composite electrolyte includes an electron-accepting atom constituting the Lewis acid group and an electron-donating atom constituting the ion-dissociative group, the atoms being bonded to each other by an interaction. Therefore, it is possible to provide an ion-conductive composite electrolyte in which ionic dissociation is accelerated to improve the ion-conducting property, and in which, when the ion-dissociative group is a proton-dissociative group, swelling with water is suppressed to achieve insolubilization in water, and crossover can be suppressed.

In addition, according to the present invention, the membrane-electrode assembly includes an electrolyte membrane composed of the above-described ion-conductive composite electrolyte and catalyst electrodes in which a catalyst metal is carried on an electrically conductive carrier, wherein the catalyst electrodes are arranged on both sides of the electrolyte membrane. Therefore, it is possible to provide a membrane-electrode assembly which is suitable for use in a fuel cell, in which ionic dissociation is accelerated to improve the ion-conducting property, and in which, when the ion-dissociative group is a proton-dissociative group, swelling with water is suppressed to achieve insolubilization in water, and the permeability of methanol or the like is decreased to suppress methanol crossover or the like.

In addition, according to the present invention, the electrochemical device such as a fuel cell includes the above-described membrane-electrode assembly. Therefore, it is possible to provide an electrochemical device, such as a fuel cell, in which ionic dissociation is accelerated to improve the ion-conducting property, and in which, when the ion-dissociative group is a proton-dissociative group, swelling with water is suppressed to achieve insolubilization in water, and the permeability of methanol or the like is decreased to suppress methanol crossover or the like.

In addition, according to the present invention, a first step of preparing a solution in which an ion-conductive composite electrolyte is dispersed and/or dissolved in a solvent having a donor number of 25 or less by adding the ion-conductive composite electrolyte to the solvent, a second step of applying the solution onto a base or impregnating a base with the solution, and a third step of removing the solution by vaporization subsequent to the second step are included. Accordingly, an ion-conductive composite electrolyte membrane can be obtained by applying the solution onto the base composed of a material that is not eroded by the solvent, then removing the solvent by vaporization, and detaching the dry membrane from the base. Alternatively, an ion-conductive composite electrolyte membrane can be obtained by impregnating the base, which is porous and is composed of a material not being eroded by the solvent, with the solution, then removing the solvent by vaporization, and drying the base. Since a solvent having a donor number of 25 or less is used as the solvent, the interaction between the ion-conductive composite electrolyte and the solution is small. Therefore, it is possible to produce an ion-conductive composite electrolyte membrane in which the amount of solvent remaining therein can be reduced and whose ionic conductivity can be increased.

### BRIEF DESCRIPTION OF DRAWINGS

FIG. 1 includes drawings illustrating a proton-conductive composite electrolyte according to an embodiment of the present invention.

FIG. 2 includes drawings illustrating examples of a Lewis acid and examples of a Lewis acid group according to an embodiment of the present invention.

FIG. 3 is a cross-sectional view illustrating a configuration example of a direct-type methanol fuel cell according to an embodiment of the present invention to which a polymer electrolyte having a Lewis acid group is applied.

FIG. 4 is a cross-sectional view illustrating a configuration example of a polymer electrolyte-type fuel cell according to an embodiment of the present invention to which a polymer electrolyte having a Lewis acid group is applied.

FIG. 5 includes drawings illustrating a fullerene derivative having proton-dissociative groups in an embodiment of the present invention.

FIG. 6 is a drawing illustrating a PVdF-HFP copolymer used as a binding agent in an embodiment of the present invention.

FIG. 7 is a table showing the donor number (DN) of various solvents including solvents used in forming an electrolyte membrane in an embodiment of the present invention.

FIG. 8 includes drawings illustrating chemical formulae of the various solvents illustrated in FIG. 7, according to an embodiment of the present invention.

FIG. 9 is a graph illustrating the effect of a solvent on the ionic conductivity in Example of the present invention, the solvent remaining in a compact composed of a fullerene derivative.

FIG. 10 is a graph illustrating the humidity dependence of the ionic conductivity of a compact composed of a fullerene derivative in Example of the present invention.

FIG. 11 is a graph illustrating the effect of a solvent on the ionic conductivity in Example of the present invention, the solvent remaining in a compact composed of a pitch material into which a sulfonic acid group is introduced.

FIG. 12 is a graph illustrating the humidity dependence of the ionic conductivity of an electrolyte membrane containing a fullerene derivative in Example of the present invention.

FIG. 13 is a graph illustrating characteristics of a fuel cell including an electrolyte membrane containing a fullerene derivative in Example of the present invention.

FIG. 14 is a drawing illustrating a problem in the related art.

### DESCRIPTION OF EMBODIMENTS

In the proton-conductive composite electrolyte of the present invention, the ion-dissociative group is preferably a proton-dissociative group. According to this configuration, it is possible to provide a proton-conductive composite electrolyte in which proton dissociation is accelerated to improve the proton-conducting property, whose swelling with water is suppressed, and which can be insoluble in water.

In addition, the compound is preferably, in particular, a polymer having a plurality of the Lewis acid groups in side chains thereof. According to this configuration, it is possible to provide a proton-conductive composite electrolyte in which proton dissociation is accelerated to improve the proton-conducting property, whose swelling with water is suppressed, and which can be insoluble in water.

In addition, the proton-dissociative group is preferably at least one selected from the group consisting of a sulfonic acid group (—SO₃H), a phosphonic group (—PO(OH)₂), a bis-sulfonimide group (—SO₂NHSO₂—), a sulfonamide group (—SO₂NH₂), a carboxyl group (—COOH), a diphosphonomethano group (═C(PO(OH)₂)₂), and a disulfonomethano group (═C(SO₃H)₂). According to this configuration, proton dissociation is accelerated to improve the proton-conducting property.

In addition, the electron-accepting atom constituting the Lewis acid group is preferably boron (B) or aluminum (Al). According to this configuration, proton dissociation is accelerated to improve the proton-conducting property.

In addition, the electrolyte is preferably a fullerene compound having the above-mentioned proton-dissociative group such as a sulfonic acid group (—SO₃H). According to this configuration, it is possible to provide a proton-conductive composite electrolyte in which proton dissociation is accelerated to improve the proton-conducting property, and whose swelling with water is suppressed, and which can be insoluble in water. In addition to such a fullerene compound, at least one selected from the group consisting of a polymer having, in side chains thereof, a plurality of fullerene compounds each having the proton-dissociative group, a polymer in which a plurality of fullerene compounds each having the proton-dissociative group are linked to each other, and a polymer having a plurality of the proton-dissociative groups in side chains thereof may also be used.

In the membrane-electrode assembly of the present invention, the catalyst electrodes preferably contain the above ion-conductive composite electrolyte. According to this configuration, in the case where the ion-dissociative group is a proton-dissociative group, ionic dissociation is accelerated, proton conduction is performed smoothly, and catalyst electrodes having a stable structure can be realized.

In the method for producing an ion-conductive composite electrolyte membrane of the present invention, the solvent used in the first step preferably has a donor number of 8 or more. According to this configuration, since the interaction between the ion-conductive composite electrolyte and the solvent is small, the amount of the solvent remaining in the electrolyte membrane can be decreased. Thus, an ion-conductive composite electrolyte membrane that has high proton conductivity and that is suitable for use in a fuel cell can be obtained.

In addition, it is preferable to use the ion-conductive composite electrolyte in which an electron-accepting atom constituting the Lewis acid group and an electron-donating atom constituting the ion-dissociative group are bonded to each other. According to this configuration, ionic dissociation is accelerated to improve the ion-conducting property, and the interaction between the ion-conductive composite electrolyte and the solution is small. Therefore, it is possible to obtain an ion-conductive composite electrolyte membrane in which the amount of the solvent remaining therein can be reduced and whose ionic conductivity can be increased. In addition, in the case where the ion-dissociative group is a proton-dissociative group, it is possible to obtain an ion-conductive composite electrolyte membrane whose swelling with water is suppressed and which can be insoluble in water, and which can suppress crossover.

The ion-conductive composite electrolyte is preferably a proton-conductive composite electrolyte having a proton-dissociative group. According to this configuration, an ion-conductive composite electrolyte membrane which has high proton conductivity and which is suitable for use in a fuel cell can be obtained.

In addition, in the first step, a polymer binder is preferably added to the solvent together with the ion-conductive composite electrolyte. According to this configuration, it is possible to obtain an ion-conductive composite electrolyte membrane which has an improved strength, which withstands bending, and which has improved reliability.

In addition, the solvent used in the first step preferably satisfies that a compact formed by using a powder obtained by drying the solvent at 100° C. in a vacuum from a dispersion liquid in which the ion-conductive composite electrolyte is dispersed in the solvent has an ionic conductivity of 1×10⁻⁴ S/cm. According to this configuration, since the interaction between the ion-conductive composite electrolyte and the solvent is small, it is possible to obtain an ion-conductive composite electrolyte membrane in which the amount of the solvent remaining therein can be reduced, which has high proton conductivity, and which is suitable for use in a fuel cell.

### DESCRIPTION OF EMBODIMENTS

Regarding proton-conductive composite electrolytes, embodiments of the present invention will now be described in detail with reference to the drawings.

<Proton-Conductive Composite Electrolyte Containing Electrolyte Having Proton-Dissociative Group and Compound having Lewis Acid Group>

In the description below, MXₙ₋₁ obtained by removing one X from a Lewis acid represented by a general formula MXₙ (n≧3) (wherein M represents a polyvalent element, and X represents an anionic group) is referred to as “Lewis acid group”. Note that the anionic group X may also be represented by R.

The proton-conductive composite electrolyte according to the present invention includes an electrolyte having a proton-dissociative group and a compound having a Lewis acid group, is formed by bonding an atom M that constitutes the Lewis acid group MXₙ₋₁ and that accepts an electron to an atom that constitutes the proton-dissociative group, which is an anionic group, and that donates an electron, and is preferably used in a fuel cell.

The compound having a Lewis acid group is, for example, a Lewis acid compound MXₙ or a polymer in which a plurality of Lewis acid groups MXₙ₋₁ are bonded to the main chain or side chains (in particular, side chains).

The atom M that constitutes the Lewis acid group MXₙ₋₁ and that accepts an electron is preferably boron (B) or aluminum (Al) from the standpoint of reactivity, and X is preferably a halogen atom.

In addition, the proton-dissociative group is preferably a sulfonic acid group (—SO₃H), which has a high dissociation property of a proton. Alternatively, the proton-dissociative group may be a phosphonic group (—PO(OH)₂), a bis-sulfonimide group (—SO₂NHSO₂—), a sulfonamide group (—SO₂NH₂), a carboxyl group (—COOH), a diphosphonomethano group (═C(PO(OH)₂)₂), or a disulfonomethano group (═C(SO₃H)₂). A plurality of such proton-dissociative groups are preferably introduced into side chains of a polymer or fullerene.

The electrolyte having a proton-dissociative group is, for example, a fluorine-containing electrolyte, an electrolyte composed of a hydrocarbon-based resin, an inorganic resin, a hybrid resin of an organic resin and an inorganic resin, or the like, or a fullerene compound.

A proton-conductive composite electrolyte membrane-catalyst electrode (MEA, membrane-electrode assembly) including a membrane composed of the proton-conductive composite electrolyte according to the present invention and catalyst electrodes provided so as to be in close contact with both sides of this membrane (membranous electrodes including a catalyst metal carried on an electrically conductive carrier) is suitably used in a fuel cell.

This proton-conductive composite electrolyte includes an electrolyte having a proton-dissociative group and a compound having a Lewis acid group, in which the Lewis acid group and the proton-dissociative group are bonded to each other. Accordingly, proton dissociation is accelerated to improve the proton-conducting property, swelling of the electrolyte with water can be suppressed, and the electrolyte can be made insoluble in water. Furthermore, by using, as the electrolyte, a resin having a low methanol permeability and having heat resistance, e.g., sulfonated polyphenoxybenzoyl phenylene (S—PPBP), the methanol permeability can be decreased to suppress methanol crossover, and heat resistance can be improved.

By using this proton-conductive composite electrolyte as an electrolyte membrane for a fuel cell, it is possible to realize a fuel cell which has a low cell resistance and in which methanol crossover is suppressed.

Furthermore, when this proton-conductive composite electrolyte is used as an electrolyte in catalyst electrodes for a fuel cell, proton conduction can be performed smoothly, and catalyst electrodes having a stable structure can be realized.

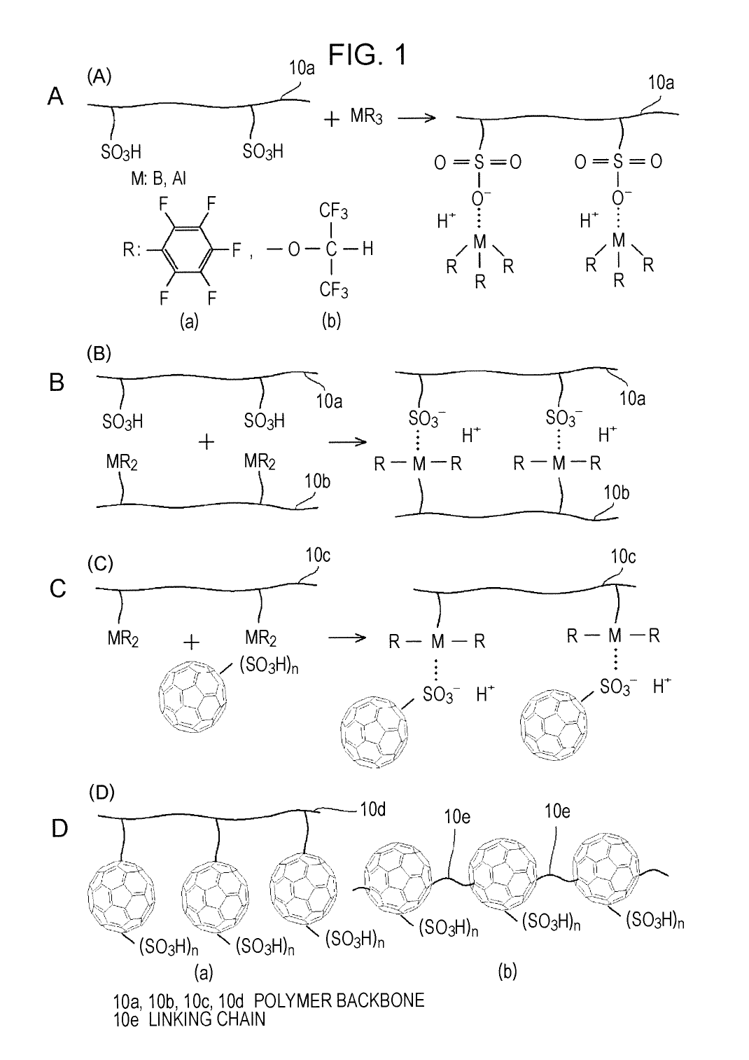

FIG. 1 includes drawings illustrating a proton-conductive composite electrolyte according to an embodiment of the present invention. FIG. 1(A) illustrates a proton-conductive composite electrolyte formed by an interaction between an electrolyte (polymer) having a plurality of proton-dissociative groups in side chains thereof and a compound (low-molecular compound) MR₃ having a Lewis acid group. FIG. 1(B) illustrates a proton-conductive composite electrolyte formed by an interaction between an electrolyte (polymer) having a plurality of proton-dissociative groups in side chains thereof and a compound (polymer) having a plurality of Lewis acid groups in side chains thereof. FIG. 1(C) illustrates a proton-conductive composite electrolyte formed by an interaction between a fullerene compound having a proton-dissociative group and a compound (polymer) having a plurality of Lewis acid groups MR₂ in side chains thereof. FIG. 1(D) illustrates (a) a polymer electrolyte having a plurality fullerene compounds in side chains thereof, the fullerene compounds each having a proton-dissociative group, and (b) an electrolyte (polymer) in which a plurality of fullerene compounds each having a proton-dissociative group are linked to each other, (a) and (b) being capable of being used instead of the fullerene compound illustrated in FIG. 1(C).

FIG. 1(A) illustrates a proton-conductive composite electrolyte formed by an electrolyte composed of a polymer having sulfonic acid groups (—SO₃H) as proton-dissociative groups in side chains of a polymer backbone 10a and a Lewis acid compound MR₃ having a Lewis acid group.

Note that, in FIG. 1, MR₂ obtained by removing one R from the Lewis acid compound MR₃ is referred to as “Lewis acid group”. Accordingly, the Lewis acid compound MR₃ is a compound having the Lewis acid group MR₂. In addition, the proton-conductive composite electrolyte is a polymer electrolyte having a Lewis acid group, and a membrane (polymer electrolyte membrane) is formed using this polymer electrolyte.

In the example illustrated in FIG. 1(A), in the Lewis acid compound MR₃, M is aluminum (Al) or boron (B), and R is a (a) pentafluorophenyl group (—C₆F₅) or a (b) hexafluoroisopropoxyl group (—OCH(CF₃)₂).

As illustrated in FIG. 1(A), by adding the Lewis acid compound to the polymer electrolyte having a plurality of sulfonic acid groups in side chains thereof, proton dissociation of the sulfonic acid groups is accelerated by an interaction (giving and receiving of electrons) between the sulfonic acid groups of the electrolyte and the Lewis acid compound MR₃, protons are dissociated from the sulfonic acid groups of the side chains of the polymer backbone 10a, a coordination bond is formed between M (electron acceptor), which is a center element of the Lewis acid compound MR₃, and O⁻ (electron donor) of a sulfonic acid group from which a proton has been dissociated, thus forming a proton-conductive composite electrolyte. Accordingly, a proton-conductive composite electrolyte having an excellent proton-conducting property can be obtained. In addition, since the electrolyte is composed of a polymer, an electrolyte that is insolubilized in water is provided.

FIG. 1(B) illustrates a proton-conductive composite electrolyte formed by an electrolyte composed of a polymer having sulfonic acid groups (—SO₃H) as proton-dissociative groups in side chains of a polymer backbone 10a, and a compound composed of a polymer having Lewis acid groups MR₂ in side chains of a polymer backbone 10b. R in each of the Lewis acid groups MR₂ is the same as (a) or (b) illustrated in FIG. 1(A).

As illustrated in FIG. 1(B), by adding the polymer having a plurality of Lewis acid groups MR₂ in side chains thereof to the polymer electrolyte having a plurality of sulfonic acid groups in side chains thereof, proton dissociation of the sulfonic acid groups is accelerated by an interaction between the sulfonic acid groups of the electrolyte and the Lewis acid groups MR₂, protons are dissociated from the sulfonic acid groups of the side chains of the polymer backbone 10a, and a coordination bond is formed between M (electron acceptor), which is a center element of the Lewis acid group MR₂, and O⁻ (electron donor) of a sulfonic acid group from which a proton has been dissociated, thus forming a proton-conductive composite electrolyte. Accordingly, as in the case of FIG. 1(A), a proton-conductive composite electrolyte having an excellent proton-conducting property can be obtained. In addition, water resistance is further improved by the bonding between the two polymers.

A proton-conductive composite electrolyte having an excellent proton-conducting property can be formed by using a compound that has a proton-dissociative group and that does not form a polymer without using, as an electrolyte, a polymer having proton-dissociative groups in side chains thereof.

For example, it is possible to use a fullerene compound which is a fullerene derivative including a fullerene molecule (forming a spherical cluster molecule) such as C₃₆, C₆₀, C₇₀, C₇₆, C₇₈, C₈₀, C₈₂, or C₈₄ as a parent substance and in which a proton-dissociative group such as a sulfonic acid group is bonded to a carbon atom of the parent substance either directly or with a linking chain (linker) therebetween.

FIG. 1(C) illustrates a proton-conductive composite electrolyte formed by an electrolyte that is composed of a fullerene compound including fullerene (C₆₀) and a proton-dissociative group bonded to the fullerene (C₆₀), the proton-dissociative group being a sulfonic acid group (—SO₃H)ₙ, and that does not form a polymer and a polymer having a plurality of Lewis acid groups MR₂ in side chains of a polymer backbone 10c.

It should be noted that, in FIGS. 1(C) and 1(D), the sulfonic acid group “(—SO₃H)ₙ” means that at least one sulfonic acid group (—SO₃H), the number of which is n (n=1 to 12), is bonded to a corresponding carbon atom of the parent substance of the fullerene compound either directly or with a linking chain (linker) therebetween. Instead of the sulfonic acid groups (—SO₃H), other proton-dissociative groups may be bonded to carbon atoms of the parent substance of the fullerene compound (this also applies to the examples described above).

As illustrated in FIG. 1(C), by adding the polymer having Lewis acid groups MR₂ in side chains thereof to the electrolyte composed of a fullerene compound having a sulfonic acid group, proton dissociation of the sulfonic acid group is accelerated by an interaction between the sulfonic acid group of the electrolyte and a Lewis acid group MR₂ of the polymer, a proton is dissociated from the sulfonic acid group of a side chain of the fullerene compound, and a coordination bond is formed between M (electron acceptor), which is a center element of the Lewis acid group MR₂, and O⁻ (electron donor) of the sulfonic acid group from which the proton has been dissociated, thus forming a proton-conductive composite electrolyte. Accordingly, as in the cases of FIGS. 1(A) and 1(B), a proton-conductive composite electrolyte having an excellent proton-conducting property can be obtained. Even when the fullerene compound is soluble in water, it is possible to obtain a proton-conductive composite electrolyte that is insolubilized in water because of the bonding with the polymer having Lewis acid groups.

Instead of the fullerene compound illustrated in FIG. 1(C), a polymer including a plurality of the fullerene compounds illustrated in FIG. 1(C) can also be used as an electrolyte, and a proton-conductive composite electrolyte having an excellent proton-conducting property can be obtained as in the cases of FIGS. 1(A), 1(B), and 1(C).

FIG. 1(D) illustrates an example of an electrolyte composed of a polymer having, in side chains thereof, a plurality of the fullerene compounds illustrated in FIG. 1(C), and illustrates (a) an electrolyte composed of a polymer having a plurality of the fullerene compounds each having a sulfonic acid group (—SO₃H)ₙ in side chains of a polymer backbone 10d and (b) an electrolyte in which a plurality of the fullerene compounds each having a sulfonic acid group (—SO₃H)ₙ are linked to each other, with a linking chain 10e therebetween, to form a polymer. Even in the case where the fullerene compound is soluble in water, the electrolytes shown in FIG. 1(D) each composed of a polymer containing a fullerene compound is insoluble in water.

In FIG. 1, a description has been made by taking a sulfonic acid group (—SO₃H) as an example of the proton-dissociative group. However, the proton-dissociative group may be a group selected from those described below.

(Proton-Dissociative Group)

The proton-dissociative group is a functional group from which a proton can be removed by ionization, and represented by a formula —XH, wherein X is any divalent atom or atomic group. Examples of the proton-dissociative group, which include the above-mentioned groups, include a hydroxyl group —OH, a mercapto group —SH, a carboxyl group —COOH, a sulfonic acid group —SO₂OH, a sulfonamide group —SO₂NH₂, a bis-sulfonimide group —SO₂NHSO₂—, a bis-sulfonimide group —SO₂NHSO₂—, a sulfoncarbonimide group —SO₂NHCO—, a biscarbonimide group —CONHCO—, a phosphonomethano group ═CH(PO(OH)₂), a diphosphonomethano group ═C(PO(OH)₂)₂, a disulfonomethano group (═C(SO₃H)₂), a phosphonomethyl group —CH₂(PO(OH)₂), a diphosphonomethyl group —CH(PO(OH)₂)₂, a sulfino group —SO(OH), a sulfeno group —S(OH), a sulfate group —OSO₂OH, a phosphonic acid group —PO(OH)₂, a phosphine group —HPO(OH), a phosphate group —O—PO(OH)₂ and —OPO(OH)O—, a phosphonyl group —HPO, and a phosphinyl group —H₂PO. The proton-dissociative group may be a derivative obtained by substituting any of these proton-dissociative groups with a substituent.

(Electrolyte Having Proton-Dissociative Group)

Various electrolytes can be used as the electrolyte having a proton-dissociative group. For example, an organic resin (organic polymer) can be used.

Known electrolytes having a proton-conducting property, such as a fluorine-containing electrolyte and a hydrocarbon-based electrolyte can be used, and an electrolyte membrane can be formed by using any of these electrolytes. The formation of this electrolyte membrane will be described below.

As the fluorine-containing electrolyte having a proton-dissociative group, it is possible to use known fluorine-containing electrolytes composed of, for example, a resin containing, as a base polymer, a perfluorocarbon sulfonic acid-based polymer, a polytrifluorostyrene sulfonic acid-based polymer, a perfluorocarbon phosphonic acid-based polymer, a trifluorostyrene sulfonic acid-based polymer, an ethylene tetrafluoroethylene-g-styrene sulfonic acid-based polymer, an ethylene-tetrafluoroethylene copolymer, a polyvinylidene fluoride-perfluorocarbon sulfonic acid-based polymer, an ethylene-ethylene tetrafluoride copolymer, or trifluorostyrene.

As the hydrocarbon-based electrolyte having a proton-dissociative group, it is possible to use known hydrocarbon-based electrolyte composed of, for example, sulfonated polyethersulfone (S-PES), PBI (polybenzimidazole), PBO (polybenzoxazole), S-PPBP (sulfonated polyphenoxybenzoyl phenylene), S-PEEK (sulfonated polyether ether ketone), sulfonamide polyethersulfone, sulfonamide polyether ether ketone, sulfonated cross-linked polystyrene, sulfonamide cross-linked polystyrene, sulfonated polytrifluorostyrene, sulfonamide polytrifluorostyrene, sulfonated polyaryl ether ketone, sulfonamide polyaryl ether ketone, sulfonated poly(aryl ether sulfone), sulfonamide poly(aryl ether sulfone), polyimide, sulfonated polyimide, sulfonamide polyimide, sulfonated 4-phenoxybenzoyl-1,4-phenylene, sulfonamide 4-phenoxybenzoyl-1,4-phenylene, phosphonated 4-phenoxybenzoyl-1,4-phenylene, sulfonated polybenzimidazole, sulfonamide polybenzimidazole, phosphonated polybenzimidazole, sulfonated polyphenylene sulfide, sulfonamide polyphenylene sulfide, sulfonated polybiphenylene sulfide, sulfonamide polybiphenylene sulfide, sulfonated polyphenylene sulfone, sulfonamide polyphenylene sulfone, sulfonated polyphenoxybenzoyl phenylene, sulfonated polystyrene-ethylene-propylene, sulfonated polyphenylene imide, polybenzimidazole-alkyl sulfonic acid, or sulfoallylated polybenzimidazole.

In addition, an electrolyte composed of a hybrid polymer of an inorganic resin and an organic resin such as a hydrocarbon-based electrolyte or a fluorine-containing electrolyte can also be used. In this case, the organic resin and/or the inorganic resin has a proton-dissociative group. For example, as the inorganic resin, an organic silicon polymer having a Si—O bond in the main backbone can be used, and a polysiloxane compound having a group substituted with sulfonic acid in side chains thereof can be used.

<Lewis Acid and Lewis Acid Groups>

Next, a description will be made of examples of the Lewis acid and examples of the functional group (Lewis acid group) acting as a Lewis acid, the Lewis acid and the Lewis acid group being capable of being used for forming the proton-conductive composite electrolytes illustrated in FIG. 1.

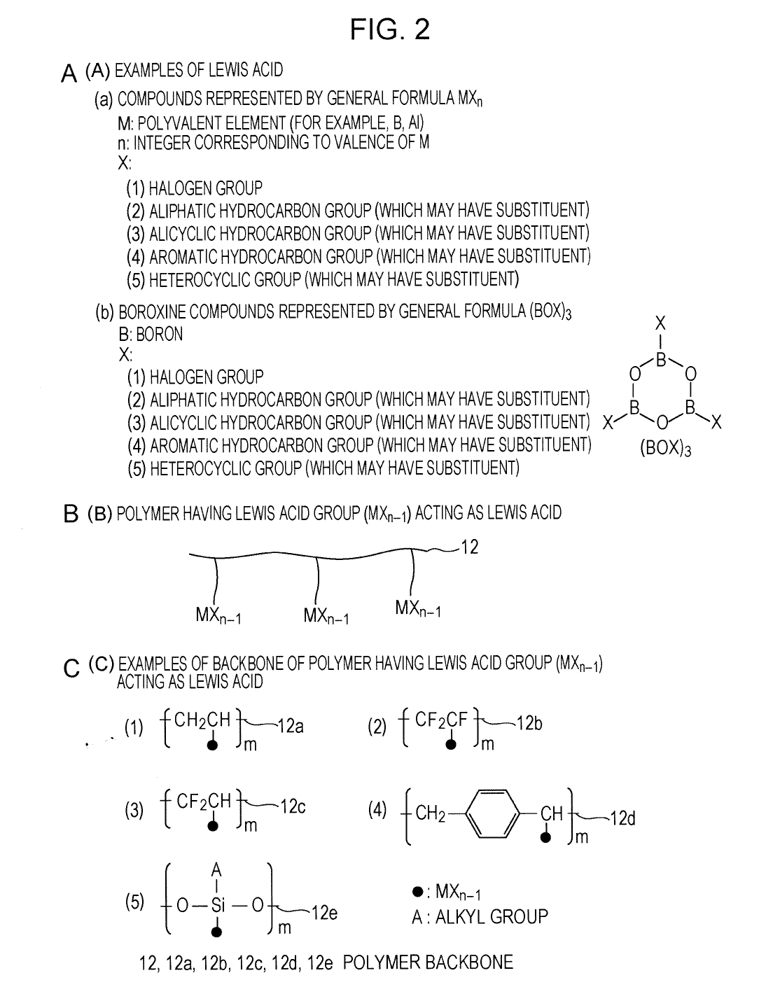

FIG. 2 includes drawings illustrating examples of the Lewis acid and examples of the functional group (Lewis acid group) acting as a Lewis acid, according to an embodiment of the present invention.

FIG. 2(A) illustrates, as examples of the Lewis acid, examples of (a) compounds represented by a general formula MXₙ, and (b) compounds represented by a general formula (BOX)₃. FIG. 2(B) schematically illustrates an electrolyte composed of a polymer having Lewis acid groups (functional groups) MXₙ₋₁ in side chains of a polymer backbone 12. FIG. 2(C) illustrates polymer backbones having Lewis acid groups (functional groups) MXₙ₋₁ in side chains of polymer backbones 12a to 12e.

The Lewis acid compounds illustrated in (a) of FIG. 2(A) and represented by the general formula MXₙ (n≧3) are inorganic or organic compounds. M is a polyvalent element which is a center atom of the Lewis acid MXₙ, and n is preferably 3, 4, or 5. M is an element of, for example, Al, B, Ti, Zr, Sn, Zn, Ga, Bi, Sb, Si, Cd, V, Mo, W, Mn, Fe, Cu, Co, Pb, Ni, Ag, Ce, or a lanthanoid element (such as Sc, Yb, or La).

Xs are each an anionic group constituting the Lewis acid MXₙ, and are at least one selected from (1) halogen groups, (2) aliphatic hydrocarbon groups, (3) alicyclic hydrocarbon groups, (4) aromatic hydrocarbon groups, and (5) heterocyclic groups. All Xs, the number of which is n, may be different from each other or some of or all of Xs may be the same. In addition, among Xs, the number of which is n, two of Xs may be bonded to each other to form a ring, and furthermore, this group may have a substituent.

Here, each of the aliphatic hydrocarbon groups is a monovalent group that is a residue obtained by removing one hydrogen atom (H) from an aliphatic hydrocarbon compound, and each of the aliphatic hydrocarbon groups may be substituted with any substituent.

In addition, each of the alicyclic hydrocarbon groups is a monovalent group that is a residue obtained by removing one hydrogen atom (H) from an alicyclic hydrocarbon compound, and the each of the alicyclic hydrocarbon groups may be substituted with any substituent.

In addition, each of the aromatic hydrocarbon groups is a monovalent group that is a residue obtained by removing one hydrogen atom (H) from an aromatic hydrocarbon compound, and each of the aromatic hydrocarbon groups may be substituted with any substituent.

In addition, each of the heterocyclic groups is a monovalent group that is a residue obtained by removing one hydrogen atom (H) from a heterocyclic compound, and each of the heterocyclic groups may be substituted with any substituent.

Examples of a halogen compound represented by the general formula MXₙ include a boron halide represented by BX₃, an aluminum halide represented by AlX₃, a phosphorus halide represented by PX₅, a silicon halide represented by SiX₄, a tin halide represented by SnX₄, fluorides such as AsF₅, VF₅, and SbF₅, and other compounds such as FeCl₃, TiCl₄, MoCl₅, and WCl₅.

Examples of the organic group X in the organic compound represented by the general formula MXₙ include various organic acid groups such as a sulfonic acid group and a phosphate group and various organic groups. Each of the organic groups may be substituted with any substituent.

Examples of the organic group include alkyl groups (such as a methyl group, an ethyl group, a propyl group, and a dodecyl group), cycloalkyl groups (such as a cyclopropyl group and a cyclohexyl group), alkoxy groups (such as a methoxy group and an ethoxy group), alkenyl groups (such as a vinyl group, an allyl group, and a cyclohexenyl group), alkynyl groups (such as an ethynyl group, a 2-propenyl group, and a hexadecynyl group), aralkyl groups (such as a benzyl group, a diphenylmethyl group, and a naphthylmethyl group), aryl groups (such as a phenyl group, a naphthyl group, and an anthryl group), halogen group (a chlorine group, a bromine group, a fluorine group, and an iodine group), aryloxy groups (such as a phenoxy group), alkylthio groups (such as a methylthio group), arylthio groups (such as a phenylthio group), acyloxy groups (such as an acetoxy group), an amino group, a cyano group, a nitro group, a hydroxy group, a formyl group, alkylamino groups (such as a methylamino group and a butylamino group), arylamino groups (such as a phenylamino group), carbonamide groups (such as an acetylamino group and a propanoylamino group), sulfonamide groups (such as a methanesulfonamide group and a benzenesulfonamide group), acyl groups (such as an acetyl group, a benzoyl group, and a pivaloyl group), sulfonyl groups (such as a methanesulfonyl group and a benzenesulfonyl group), sulfinyl groups (such as a methanesulfinyl group), a carboxylic acid group, a sulfonic acid group, a phosphonic acid group, a triflate group (a trifluoromethanesulfonate group, a CF₃SO₃ group), and heterocyclic groups. Examples of the heterocyclic groups include a pyrrole group, an indole group, a furan group, a thiophene group, an imidazole group, a thiazole group, a pyridine group, a pyran group, a thiopyran group, an oxadiazole group, and a thiadiazole group.

More specifically, examples of the organic compound include aluminum alkoxides such as aluminum triethoxide, aluminum triisopropoxide, aluminum tri-s-butoxide, and aluminum tri-t-butoxide; boron alkoxides such as trimethoxyborane and tris(phenoxy)borane; scandium alkoxides such as scandium triisopropoxide; titanium alkoxides such as titanium tetraethoxide, titanium tetraethoxide, titanium tetraisopropoxide, titanium tetra-n-butoxide, titanium tetra-t-butoxide, and titanium tetraphenoxide; zirconium alkoxides such as zirconium tetraisopropoxide; tin alkoxides such as tin tetraisopropoxide; and metal triflates such as ytterbium triflate.

The boroxine compound illustrated in (b) of FIG. 2(A) and represented by the general formula (BOX)₃ is a Lewis acid compound in which substituents X are bonded to boron atoms B of a six-membered ring including boron atoms B and oxygen atoms O alternately bonded to each other. Similarly to (a) of FIG. 2(A), Xs are at least one selected from halogen groups, aliphatic hydrocarbon groups, alicyclic hydrocarbon groups, aromatic hydrocarbon groups, heterocyclic groups, and the like. Each of Xs may be substituted with any substituent. Furthermore, three Xs in the boroxine compound may be generally different from each other, or two or three Xs of the three Xs may be the same.

The group X in the boroxine compound represented by the general formula (BOX)₃ is, for example, an alkyl group, a halogen group such as a fluorine group, a cyano group, a nitro group, an acyl group, a sulfonyl group, an alkoxy group, an aryloxy group, an alkyl group substituted with fluorine, such as a trifluoromethyl group, an aryl group substituted with fluorine, a heterocyclic group, or the like.

More specifically, examples of the boroxine compound include trimethylboroxin, 2,4,6-triethylboroxine, tributylboroxin, 2,4,6-tri-tert-butylboroxine, 2,4,6-tricyclohexylboroxin, trimethoxyboroxin, 2,4,6-triphenylboroxin, and 2,4,6-tris[3-(trifluoromethyl)phenyl]boroxine.

The polymer illustrated in FIG. 2(B) and having Lewis acid groups each represented by a general formula MXₙ₋₁ in side chains thereof, the Lewis acid groups each being obtained by removing one X from a Lewis acid compound represented by the general formula MXₙ, acts as a Lewis acid. The Lewis acid groups MXₙ₋₁ are each bonded to a polymer chain either directly or with a sulfonic acid (SO₃) group or a sulfate (SO₄) group therebetween. Alternatively, the Lewis acid groups are each bonded to either a side chain of a polymer chain or a molecular chain for linking, the molecular chain being bonded as a side chain of a polymer chain. The polymer chain and the molecular chain for linking are hydrophobic and are not easily hydrolyzed. The molecular chain for linking may include a hydrocarbon group, specifically, a hydrocarbon group (which may have a substituent) including a cycloalkyl group, an aryl group, or the like. Note that the group X corresponds to the group R in FIGS. 1(B) and 1(C).

The polymer illustrated in FIG. 2(B) and having the Lewis acid groups MXₙ₋₁ in side chains of the polymer backbone 12 is prepared by, for example, allowing a polymer to react with chlorosulfonic acid to introduce a sulfonic acid group into a side chain, and by allowing a Lewis acid compound MXₙ to react with this sulfonic acid group to introduce a Lewis acid group MXₙ₋₁ into the side chain.

The Lewis acid group MXₙ₋₁ is a group MXₙ₋₁ obtained by removing one group X from a Lewis acid compound represented by MXₙ (n≧3) described in (a) of FIG. 2(A). Therefore, a description of specific examples thereof is not repeated.

The Lewis acid group MXₙ₋₁ can be linked to a side chain of various polymer backbones. As described above, the polymer chain to which the Lewis acid group MXₙ₋₁ is bonded is a hydrophobic polymer that is not easily dissolved in water or aqueous media, and is a known polymer such as a fluorine-containing polymer, a hydrocarbon-based polymer, or a hybrid polymer (a hybrid product of an organic polymer such as a hydrocarbon-based polymer or a fluorine-containing polymer and an inorganic polymer such as a siloxane-based polymer).

Examples of the backbone of the polymer chain to which a Lewis acid group is bonded include, as illustrated in FIG. 2(C), (1) a polymer backbone in which a hydrogen atom (H) of polyethylene (PE) is substituted with a Lewis acid group, (2) a polymer backbone in which a fluorine atom (F) of polytetrafluoroethylene (PTFE) is substituted with a Lewis acid group, (3) a polymer in which a hydrogen atom (H) of polyvinylidene fluoride (PVDF) is substituted with a Lewis acid group, (4) a polymer backbone in which a hydrogen atom (H) of poly-p-xylene is substituted with a Lewis acid group, and (5) a polymer backbone in which an alkyl group (A) of an alkyl polysiloxane is substituted with a Lewis acid group. The polymer backbone may be a backbone of an addition polymer of styrene, α-methylene, divinylbenzene, or the like, or a backbone of other various types of polymers.

It should be noted that m shown in FIG. 2(C) represents the number of repetitions (degree of polymerization) of a unit structure (repeating unit of the polymer backbone) in the parentheses [ ] preceding m, and m is 2 to 100,000. Also, the number of Lewis acid groups MX₂ in the polymer having the Lewis acid groups MX₂ in the side chains thereof is 2 to 100,000.

A polymer having, as a polymer backbone, the backbone of a styrene polymer (polystyrene) ((—(C₆H₅)CH—CH₂—)ₘ) and having a structure in which —H of a phenyl group (—C₆H₅) of this polystyrene backbone is substituted with a Lewis acid group —B(C₆F₅)₂ can be synthesized as follows. For example, a polymerization initiator (1-phenylethyl bromide) and a catalyst (copper bromide (CuBr)/pentamethyldiethylenetriamine) are added to 4-trimethylsilylstyrene ((CH₃)₃Si—C₆H₄—CH═CH₂), and radical polymerization is conducted in anisole (C₆H₅OCH₃) at 110° C. to prepare a polymer having a structure in which —H of a phenyl group (—C₆H₅) of a polystyrene backbone is substituted with —Si(CH₃)₃. Next, —Si(CH₃)₃ of this polymer is substituted with a Lewis acid group —BBr₂ in dichloromethane (CH₂Cl₂) using boron tribromide (BBr₃). The polymer substituted with the Lewis acid group —BBr₂ and pentafluorophenyl copper (Cu(C₆F₅)) are allowed to react with each other in dichloromethane (CH₂Cl₂). Thus, it is possible to obtain a target polymer having a structure in which —H of the phenyl group (—C₆H₅) of the polystyrene backbone is substituted with a Lewis acid group —B(C₆F₅)₂. This polymer is equivalent to a polymer in which —H of a polyethylene backbone ((CH₂—CH₂—)ₘ) is substituted with a group —(C₆H₄)B(C₆F₅)₂.

The proton-conductive composite electrolyte containing an electrolyte having a proton-dissociative group and a compound having a Lewis acid group, which has been described with reference to FIGS. 1 and 2, is hereinafter referred to as “proton-conductive composite electrolyte having a Lewis acid group”. Next, a description will be made of the formation of an electrolyte membrane using the proton-conductive composite electrolyte having a Lewis acid group.

<Formation of Electrolyte Membrane Using Proton-Conductive Composite Electrolyte Having Lewis Acid Group>

As described above, a proton-conductive composite electrolyte having a Lewis acid group is formed by (1) an interaction between a polymer electrolyte having proton-dissociative groups in side chains thereof and a compound (which is not a polymer) having a Lewis acid group (refer to FIG. 1(A)), (2) an interaction between a polymer electrolyte having proton-dissociative groups and a polymer having Lewis acid groups in side chains thereof (refer to FIG. 1(B)), (3) an interaction between a fullerene compound having a proton-dissociative group and a polymer having Lewis acid groups in side chains thereof (refer to FIG. 1(C)), or (4) an interaction between a polymer having Lewis acid groups in side chains thereof and a polymer electrolyte having a plurality of fullerene compounds in side chains thereof, the fullerene compounds each having a proton-dissociative group, or a polymer electrolyte in which a plurality of fullerene compounds each having a proton-dissociative group are linked to each other (refer to FIG. 1(D)).

As in (1) to (4) described above, the proton-conductive composite electrolyte having a Lewis acid group is formed by an interaction between the above-described polymer electrolyte and a compound (which is not a polymer) having a Lewis acid group or an interaction between the above-described polymer electrolyte and a polymer having Lewis acid groups in side chains thereof.

This proton-conductive composite electrolyte having a Lewis acid group can be formed into a membrane by the following (a) or (b) to obtain an electrolyte membrane. (a) A mixture obtained by dispersing and/or dissolving the polymer electrolyte and/or the polymer having Lewis acid groups in the side chains thereof in a solvent is applied and the solvent is then removed by vaporization. In this case, when the polymer electrolyte and/or the polymer having Lewis acid groups in the side chains thereof intertwines to form a three-dimensional structure or polymerization of the polymer occurs and a membrane is formed, thus forming an electrolyte membrane, the electrolyte membrane can be formed without using a binding agent composed of a fluorocarbon resin such as polytetrafluoroethylene (PTFE), polyvinylidene fluoride (PVDF), or a PVdF-HFP (hexafluoropropylene) copolymer.

Alternatively, in (b), when the polymer electrolyte and/or the polymer having Lewis acid groups in the side chains thereof is not formed into a membrane, and thus no membrane is formed because, unlike in (a) above, a three-dimensional structure due to intertwinement is not formed or the polymerization of the polymer does not occur, the electrolyte membrane can be formed in accordance with an existing method using the above binding agent by dispersing and/or dissolving the polymer having Lewis acid groups in the side chains thereof, the polymer electrolyte, and the binding agent in a solvent, forming a coating membrane, and then removing the solvent by vaporization.

In each of the above cases (a) and (b), a solvent is necessary in forming an electrolyte membrane. After the formation of a coating membrane, even when the solvent is removed by vaporization, the solvent remains in the electrolyte membrane as a result of an interaction between the solvent and the Lewis acid group and/or the proton-dissociative group, and the degree to which the solvent is removed by vaporization may become insufficient. Thus, the proton conductivity of the electrolyte membrane may be decreased by the interaction between the solvent and the Lewis acid group and/or the proton-dissociative group.

In forming an electrolyte membrane, a solvent having a small interaction with a Lewis acid group and/or a proton-dissociative group is used in the present invention. As such a solvent, a solvent having a donor number of 25 or less is used. The details thereof will be described below.

Next, a description will be made of configuration examples of a fuel cell to which a proton-conductive composite electrolyte having a Lewis acid group is applied.

<Fuel Cell According to the Present Invention to which Proton-Conductive Composite Electrolyte Having Lewis Acid Group is Applied>

(Direct-Type Methanol Fuel Cell)

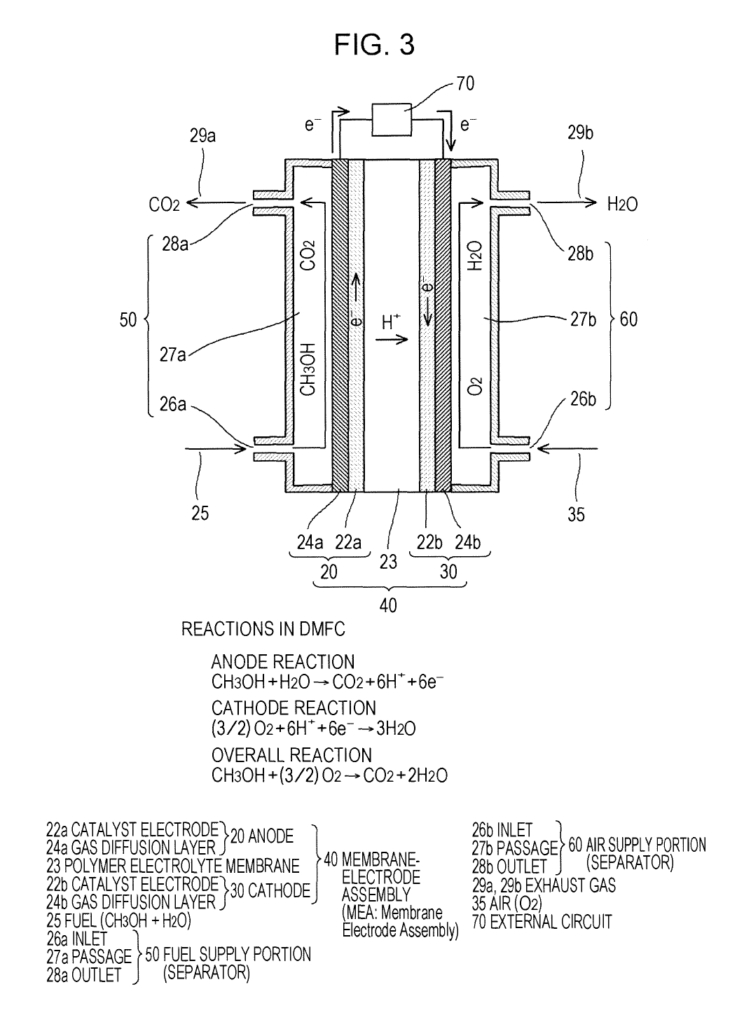

FIG. 3 is a cross-sectional view illustrating a configuration example of a DMFC (direct-type methanol fuel cell) according to an embodiment of the present invention to which a proton-conductive composite electrolyte having a Lewis acid group is applied.

As illustrated in FIG. 3, an aqueous methanol solution is allowed to flow as a fuel 25 from an inlet 26a of a fuel supply portion (separator) 50 having a flow path to a passage 27a. The fuel 25 passes through an electrically conductive gas diffusion layer 24a which is a base and reaches a catalyst electrode 22a that is held by the gas diffusion layer 24a. Methanol and water react with each other on the catalyst electrode 22a in accordance with the anode reaction shown in the lower part of FIG. 3 to produce hydrogen ions, electrons, and carbon dioxide. An exhaust gas 29a containing carbon dioxide is discharged from an outlet 28a. The produced hydrogen ions pass through a polymer electrolyte membrane 23 composed of the above-described proton-conductive composite electrolyte having a Lewis acid group, and reach a catalyst electrode 22b that is held by an electrically conductive gas diffusion layer 24b which is a base. The produced electrons pass through the gas diffusion layer 24a and an external circuit 70, further pass through the gas diffusion layer 24b, and reach the catalyst electrode 22b.

As illustrated in FIG. 3, air or oxygen 35 is allowed to flow from an inlet 26b of an air or oxygen supply portion (separator) 60 having a flow path to a passage 27b. The air or oxygen 35 passes through the gas diffusion layer 24b and reaches the catalyst electrode 22a that is held by the gas diffusion layer 24b. Hydrogen ions, electrons, and oxygen react with each other on the catalyst electrode 22b in accordance with the cathode reaction shown in the lower part of FIG. 3 to produce water. An exhaust gas 29b containing water is discharged from an outlet 28b. As shown in the lower part of FIG. 3, the overall reaction is a combustion reaction of methanol in which electrical energy is taken from methanol and oxygen, and water and carbon dioxide are discharged.

(Polymer Electrolyte-Type Fuel Cell)

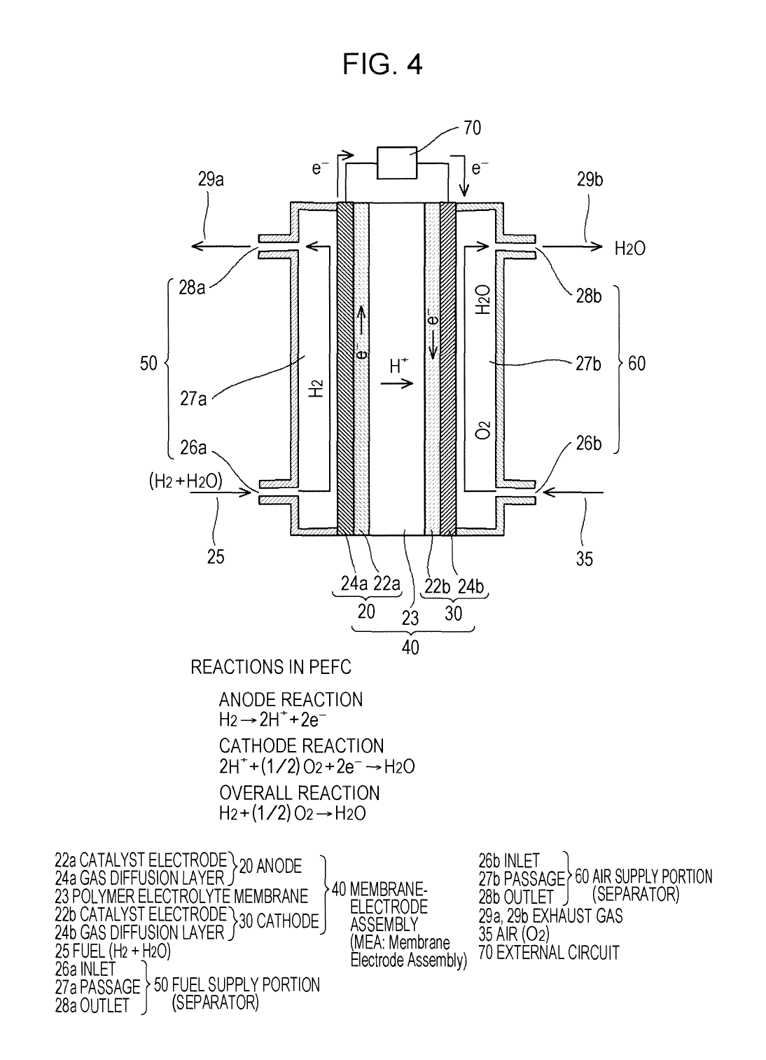

FIG. 4 is a cross-sectional view illustrating a configuration example of a PEFC (polymer electrolyte-type fuel cell) according to an embodiment of the present invention to which a proton-conductive composite electrolyte having a Lewis acid group is applied.

As illustrated in FIG. 4, humidified hydrogen gas is allowed to flow as a fuel 25 from an inlet 26a of a fuel supply portion 50 to a passage 27a. The fuel 25 passes through a gas diffusion layer 24a and reaches a catalyst electrode 22a. Hydrogen ions and electrons are produced from the hydrogen gas on the catalyst electrode 22a in accordance with the anode reaction shown in the lower part of FIG. 4. An exhaust gas 29a containing excess hydrogen gas is discharged from an outlet 28a. The produced hydrogen ions pass through a polymer electrolyte membrane 23 composed of the above-described proton-conductive composite electrolyte having a Lewis acid group, and reach a catalyst electrode 22b. The produced electrons pass through the gas diffusion layer 24a and an external circuit 70, further pass through a gas diffusion layer 24b, and reach the catalyst electrode 22b.

As illustrated in FIG. 4, air or oxygen 35 is allowed to flow from an inlet 26b of an air or oxygen supply portion 60 to a passage 27b. The air or oxygen 35 passes through the gas diffusion layer 24b and reaches the catalyst electrode 22a. Hydrogen ions, electrons, and oxygen react with each other on the catalyst electrode 22b in accordance with the cathode reaction shown in the lower part of FIG. 4 to produce water. An exhaust gas 29b containing water is discharged from an outlet 28b. As shown in the lower part of FIG. 4, the overall reaction is a combustion reaction of hydrogen gas in which electrical energy is taken from hydrogen gas and oxygen, and water is discharged.

In FIGS. 3 and 4, the polymer electrolyte membrane 23 is formed by binding a proton-conductive composite electrolyte with a binding agent (e.g., polytetrafluoroethylene (PTFE), polyvinylidene fluoride (PVDF), or the like). An anode 20 and a cathode 30 are separated by the polymer electrolyte membrane 23, and hydrogen ions and water molecules move through the polymer electrolyte membrane 23. Preferably, the polymer electrolyte membrane 23 is a membrane having a high conducting property of hydrogen ions, is chemically stable, and has a high mechanical strength.

In FIGS. 3 and 4, the catalyst electrodes 22a and 22b are formed so as to be in close contact with the gas diffusion layers 24a and 24b, respectively, which constitute electrically conductive bases serving as current collectors and which have permeability to gases and solutions. The gas diffusion layers 24a and 24b are each composed of a porous base such as carbon paper, a formed body of carbon, a sintered body of carbon, a sintered metal, or a foam metal. In order to prevent a decrease in the gas diffusion efficiency due to water produced by the driving of the fuel cell, the gas diffusion layers are subjected to a water-repellent treatment with a fluorocarbon resin or the like.

The catalyst electrodes 22a and 22b are each formed by, for example, binding a carrier carrying a catalyst composed of platinum, ruthenium, osmium, a platinum-osmium alloy, a platinum-palladium alloy, or the like with a binding agent (e.g., polytetrafluoroethylene, polyvinylidene fluoride (PVDF), or the like). As the carrier, for example, inorganic fine particles of carbon such as acetylene black or graphite, alumina, or silica are used. The membranous catalyst electrodes 22a and 22b which are bound by a binding agent are formed by applying, onto the gas diffusion layers 24a and 24b, respectively, a solution prepared by dispersing carbon particles (on which a catalyst metal is carried) in an organic solvent in which the binding agent is dissolved, and evaporating the organic solvent.

The polymer electrolyte membrane 23 is sandwiched between the catalyst electrodes 22a and 22b formed so as to be in close contact with the gas diffusion layers 24a and 24b, respectively, to form a membrane-electrode assembly (MEA) 40. The catalyst electrode 22a and the gas diffusion layer 24a constitute the anode 20, and the catalyst electrode 22b and the gas diffusion layer 24b constitute the cathode 30. The anode 20 and the cathode 30 are in close contact with the polymer electrolyte membrane 23. The catalyst electrodes 22a and 22 and the polymer electrolyte membrane 23 are assembled so as to be in close contact with each other in a state in which a proton conductor enters between carbon particles, and the catalyst electrodes 22a and 22b are impregnated with the polymer electrolyte (proton conductor). Thus, a high conducting property of hydrogen ions is maintained at the assembled interface, and the electrical resistance is maintained to be low. Note that the catalyst electrodes may contain the above-described proton-conductive composite electrolyte having a Lewis acid group. In such a case, proton conduction at the assembled interface is performed smoothly.

Incidentally, in the examples illustrated in FIGS. 3 and 4, each of the openings of the inlet 26a of the fuel 25, the outlet 28a of the exhaust gas 29a, the inlet 26b of air or oxygen (O₂) 35, and the outlet 28b of the exhaust gas 29b is arranged perpendicular to the surfaces of the polymer electrolyte membrane 23 and the catalyst electrodes 22a and 22b. Alternatively, each of the openings may be arranged in parallel with the surfaces of the polymer electrolyte membrane 23 and the catalyst electrodes 22a and 22b. Thus, various modifications can be made regarding the arrangement of the respective openings.

The fuel cells illustrated in FIGS. 3 and 4 can be produced by general methods disclosed in various documents, and thus a detailed description regarding the production is omitted.

It should be noted that, needless to say, proton-conductive composite electrolyte membranes described below can also be applied to the fuel cells illustrated in FIGS. 3 and 4.

<Solvent Used in Forming Electrolyte Membrane>

Next, solvents used in forming an electrolyte membrane will be described. A description will now be made of, as an example, a polymer electrolyte composed of a fullerene derivative in which fullerene compounds each including fullerene (C₆₀) and a proton-dissociative group bonded to the fullerene (C₆₀), the proton-dissociative group being a sulfonic acid group (—SO₃H), are linked to each other. A description will be made of, as an example, a proton-conductive composite electrolyte membrane including this fullerene derivative and a binding agent (fluorocarbon resin).

(Electrolyte: Fullerene Derivative)

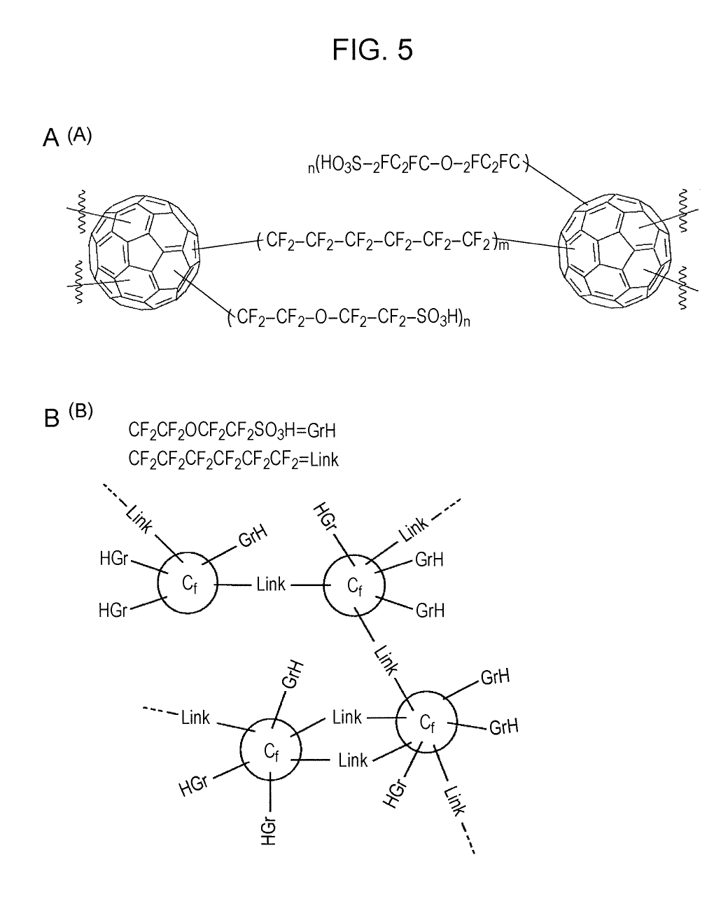

FIG. 5 includes drawings illustrating a fullerene derivative having proton-dissociative groups in an embodiment of the present invention.

As illustrated in FIG. 5(A), a fullerene derivative has a structure in which fullerene parent substances (C₆₀) are bonded to each other via linking groups —CF₂CF₂CF₂CF₂CF₂CF₂—, the number of which is m. In this structure, groups —CF₂CF₂—O—CF₂CF₂—SO₃H, the number of which is n, and each of which has a sulfonic acid group (—SO₃H) as a proton-dissociative group at an end thereof are bonded to each of the fullerene parent substances (C₆₀).

As illustrated in FIG. 5(B), when the group —CF₂CF₂—O—CF₂CF₂—SO₃H having a sulfonic acid group (—SO₃H) at an end thereof is simply denoted by -GrH and the linking group —CF₂CF₂CF₂CF₂CF₂CF₂— is simply denoted by -Link-, the fullerene derivative is a polymer having a structure in which the fullerene parent substances (C₆₀) are linked to each other with the Link therebetween, and a plurality of GrHs are bonded to each of the fullerene parent substances (C₆₀).

(Binding Agent)

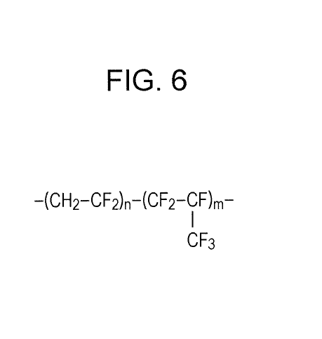

FIG. 6 is a drawing illustrating a PVdF-HFP copolymer used as a binding agent in an embodiment of the present invention.

As illustrated in FIG. 6, the PVdF-HFP copolymer used in forming an electrolyte membrane is a copolymer of polyvinylidene fluoride (PVdF) (CH₂CF₂)ₙ and hexafluoropropylene (HFP) (CF₂CF(CF₃))ₘ. This copolymer is any of an alternating copolymer, a periodic copolymer, a random copolymer, and a block copolymer, or a mixture of these.

(Effect of Solvent Used in Forming Electrolyte Membrane)

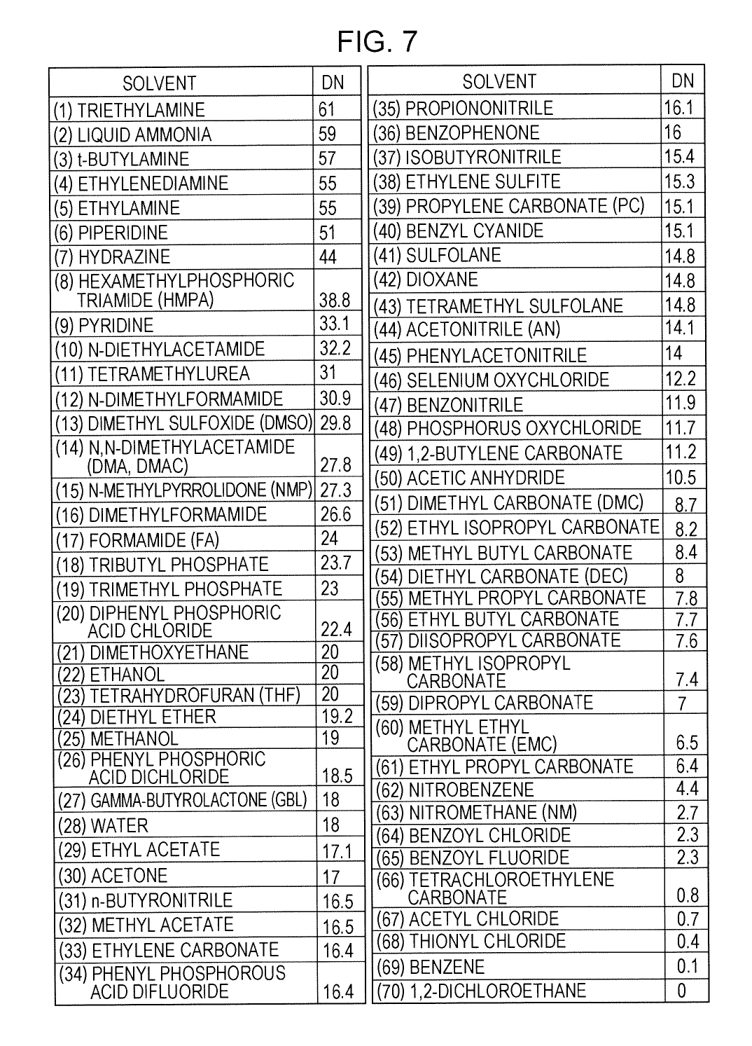

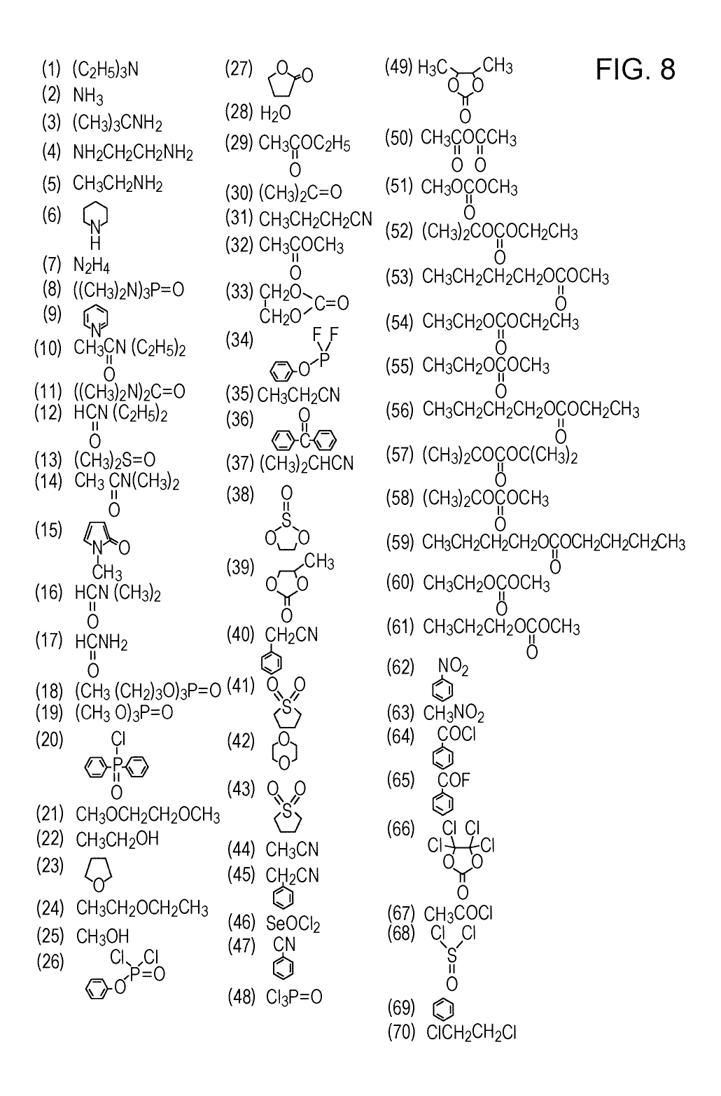

FIG. 7 is a table showing the donor number (DN) of various solvents including solvents used in forming an electrolyte membrane in an embodiment of the present invention. FIG. 8 includes drawings illustrating chemical formulae of the various solvents illustrated in FIG. 7.

The donor number (DN) of solvents is a solvent parameter defined by Gutmann as a measure of an electron-donating property of solvent molecules. As a standard acceptor, 10⁻³ M SbCl₅ in dichloroethane is selected, and the donor number is defined as a molar enthalpy value (determined by a measurement of heat quantity) of a reaction with a donor. A solvent having a larger donor number more strongly solvates cation species.

In forming an electrolyte membrane, for example, a basic solvent such as dimethylformamide or N-methylpyrrolidone is often used as a solvent that can dissolve a polymeric material functioning as a binding agent and that can disperse or dissolve an ion conductor. However, such a basic solvent having a large donor number has a strong interaction with cations, and thus solvates dissociated cations, which disturbs the ion conduction.

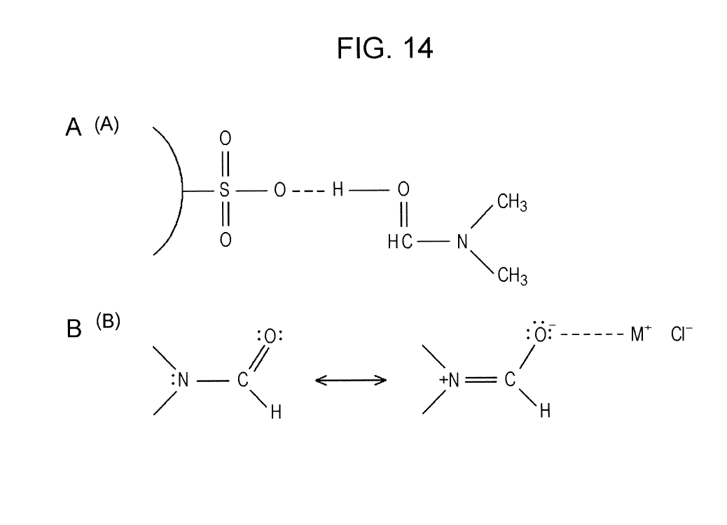

As illustrated in FIG. 14, N,N-dimethylformamide interacts with a sulfonic acid group of an electrolyte to form a hydrogen bond. Accordingly, even when an electrolyte membrane formed by using N,N-dimethylformamide is dried in a vacuum, N,N-dimethylformamide is not easily removed because of this interaction, and this solvent remains. This may cause a decrease in the ionic conductivity of the electrolyte membrane. In order to eliminate this effect of interaction, for example, an acid treatment is necessary. Furthermore, a bond based on an on-dipole interaction is formed between N,N-dimethylformamide and a chloride MCl of a metal (M), the chloride MCl being an electrolyte.

Accordingly, in order to suppress a decrease in the ionic conductivity of an electrolyte membrane, the interaction between the solvent used in forming the electrolyte membrane and a proton-dissociative group of the electrolyte is desirably smaller, and the donor number of the solvent used in forming the electrolyte membrane is desirably 25 or less, as described below.

Specific examples of the solvent having a donor number of 25 or less include tributyl phosphate, trimethyl phosphate, diphenyl phosphoric acid chloride, dimethoxyethane, ethanol, tetrahydrofuran, diethyl ether, methanol, phenyl phosphoric acid dichloride, gamma-butyrolactone, water, ethyl acetate, acetone, N-butyronitrile, methyl acetate, ethylene carbonate, phenyl phosphorous acid difluoride, propionitrile, benzophenone, isobutyronitrile, ethylene sulfite, propylene carbonate, benzyl cyanide, sulfolane, dioxane, tetramethylene sulfone, acetonitrile, phenylacetonitrile, selenium oxychloride, benzonitrile, phosphorus oxychloride, 1,2-butylene carbonate, acetic anhydride, dimethyl carbonate, ethyl isopropyl carbonate, methyl butyl carbonate, diethyl carbonate, methyl propyl carbonate, ethyl butyl carbonate, diisopropyl carbonate, methyl isopropyl carbonate, dipropyl carbonate, methyl ethyl carbonate, ethyl propyl carbonate, nitrobenzene, nitromethane, benzoyl chloride, benzoyl fluoride, tetrachloroethylene carbonate, acetyl chloride, thionyl chloride, benzene, and 1,2-dichloroethane. These solvents may be used alone or in combination of two or more solvents.

The electrolyte membrane formed using such a solvent has a very high ionic conductivity, and it is possible to provide a high-performance electrochemical device such as a fuel cell.

Next, a description will be made of Examples in which the effect of an interaction between an ion conductor and a solvent, the effect of a solvent used in forming an electrolyte membrane, and characteristics of a fuel cell and the effect of a solvent used in forming an electrolyte membrane thereof were examined.

### EXAMPLES

First, the effect of an interaction between an ion conductor and a solvent will be described.

(Effect of interaction between ion conductor and solvent)

### Example 1

Here, the above-described fullerene derivative was used as an ion conductor. The effect of an interaction between this ion conductor and various solvents will now be described.

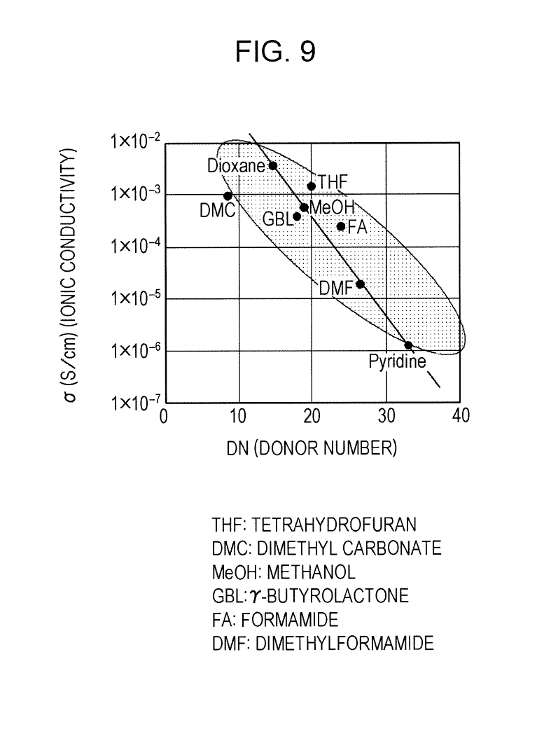

The fullerene derivative was dispersed in various solvents, and the solvents were then removed from the resulting dispersion liquids at 100° C. by vacuum drying. Subsequently, compacts were prepared. Each of the compacts was sandwiched between gold electrodes, and ionic conductivity σ thereof was measured by employing a complex impedance method. The measurement results are shown in FIG. 9. Note that these compacts contain no binding agent.

FIG. 9 is a graph illustrating the effect of a solvent on the ionic conductivity in Example of the present invention, the solvent remaining in a compact composed of a fullerene derivative. In FIG. 9, the horizontal axis represents the donor number (DN) of the solvent, and the vertical axis represents the ionic conductivity σ (S/cm²) of the compact. The name of the solvent used in preparation of the compact is denoted near each measurement point in the figure.

As shown in FIG. 9, the measurement values of the ionic conductivity σ of the compacts are distributed in an elliptical area. However, when C denotes a positive constant, except for DMC (dimethyl carbonate), the measurement values are represented by an approximate straight line logσ=−C×DN. The larger the donor number (DN) of the solvent used, the smaller the ionic conductivity σ of the compact. The ionic conductivities σ of the eight types of solvents used are within a wide range of 1.2×10⁻⁶ (S/cm²) to 3×10⁻³ (S/cm²). It is believed that the ionic conductivity σ of an electrolyte membrane formed using a solvent having a large donor number (DN) is also low.

The ionic conductivity σ of the compact is not a constant value inherent to the fullerene derivative used. It is believed that this is because the magnitude of the interaction with the fullerene derivative varies depending on the type of solvent used for dispersing the fullerene derivative, and thus the amounts of solvent remaining in the compacts differ.

It is assumed that this effect due to the difference in the interaction between the solvent and the fullerene derivative is also caused when an electrolyte membrane is formed using a binding agent and the fullerene derivative as an electrolyte. Thus, it is assumed that a difference in the ionic conductivity of the electrolyte membrane is caused depending on the solvent used in forming the electrolyte membrane.

Next, the humidity dependence of the ionic conductivity was measured for compacts prepared by using pyridine and THF (tetrahydrofuran) as a solvent, among the compacts shown in FIG. 9.

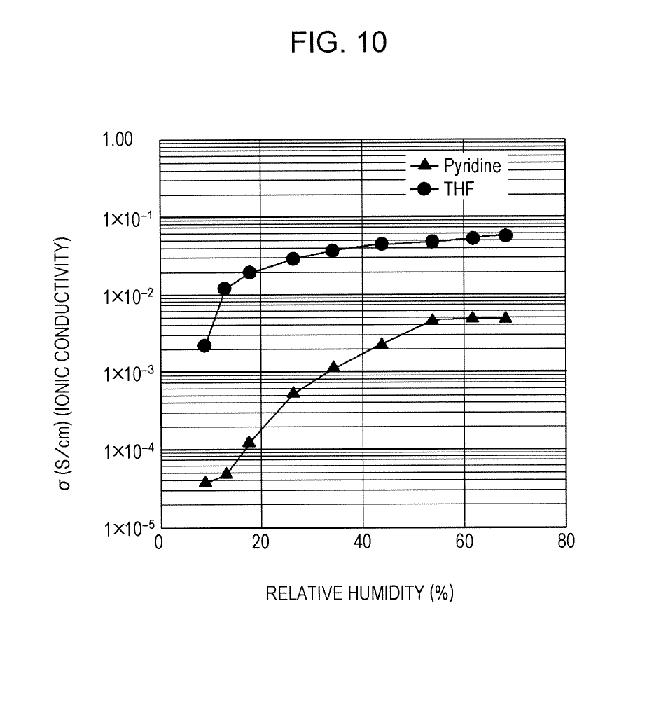

FIG. 10 is a graph illustrating the humidity dependence of the ionic conductivity of a compact composed of a fullerene derivative in Example of the present invention. In FIG. 10, the horizontal axis represents the relative humidity (%), and the vertical axis represents the ionic conductivity (S/cm²) of a compact.

As shown in FIG. 10, the ionic conductivity of the compact significantly changes depending on the humidity. The change in the ionic conductivity of the compact prepared using pyridine with respect to the change in the humidity is larger than the change in the ionic conductivity of the compact prepared using THF with respect to the change in the humidity.

The change in the ionic conductivity of the compact prepared using THF with respect to the change in the humidity is small; 2×10⁻³ to 5×10⁻², and thus it is believed that the amount of remaining THF is small. On the other hand, the change in the ionic conductivity of the compact prepared using pyridine with respect to the change in the humidity is large; 4×10⁻⁵ to 5×10⁻³, and thus it is believed that the amount of remaining pyridine is large. In addition, the ionic conductivity of the compact prepared using THF pyridine is larger than the ionic conductivity of the compact prepared using pyridine.

Thus, it is assumed that the value of ionic conductivity and the degree of change in the ionic conductivity with respect to the change in the humidity significantly vary depending on the type of solvent remaining in the compact.

It is assumed that the similar phenomenon occurs in an electrolyte membrane formed using a binding agent and a fullerene derivative as an electrolyte. It is assumed that a difference in the change in the ionic conductivity of the electrolyte membrane with respect to the change in the humidity is caused depending on the solvent used in forming the electrolyte membrane. It is believed that even when water is present in the electrolyte membrane, the solvent remaining in the electrolyte membrane significantly affects the ionic conductivity of the electrolyte membrane.

### Example 2

Here, a pitch material into which a sulfonic acid group is introduced (hereinafter referred to as “sulfonated pitch”) was used as an ion conductor. The effect of an interaction between this ion conductor and various solvents will now be described. The sulfonated pitch was synthesized as follows.

Coal tar (manufactured by Wako Pure Chemical Industries, Ltd., 10 g) is weighed in a round-bottom flask, the inside of the flask is replaced by a nitrogen flow, the whole flask is immersed in an ice bath, and the flask is slowly stirred with a stirrer. While the flask is sufficiently immersed in the ice bath, 200 mL of 25% fuming sulfuric acid (manufactured by Wako Pure Chemical Industries, Ltd.) is slowly added dropwise thereto with care so as not to generate heat. Furthermore, the flask is vigorously stirred at room temperature while being immersed in the ice bath. Three hours later, while the flask is immersed in the ice bath, ion-exchange water (500 mL) is carefully added so that the temperature is not excessively increased. Centrifugal separation of the resulting suspension is performed, and the supernatant is removed. This operation (washing operation) including the addition of ion-exchange water (500 mL), the centrifugal separation of the resulting suspension, and the removal of the supernatant is performed five times or more. After it is confirmed that sulfate ions are sufficiently removed from the supernatant aqueous solution, the resulting precipitate is dried in a vacuum at room temperature to obtain a black (slightly brownish-red) aggregate (7 g). The obtained aggregate was pulverized with a ball mill (manufactured by Fritsch GmBH), and fine particles were collected with a 32-μm mesh pass.

According to the results of organic elemental analysis of the sulfonated pitch obtained in this manner, carbon (C) was 44.5% by weight, hydrogen (H) was 3.38% by weight, sulfur (S) was 14.97% by weight, and nitrogen (N) was 0% by weight. On the basis of these analysis results, when all the sulfur (S) was sulfonated, the sulfonic acid density was calculated to be 4.68 mmol/g.

As in Example 1, the sulfonated pitch was dispersed in the same various solvents as those used in Example 1 and shown in FIG. 9. The solvents were then removed from the resulting dispersion liquids at 100° C. by vacuum drying. Subsequently, compacts were prepared. Each of the compacts was sandwiched between gold electrodes, and the ionic conductivity σ thereof was measured by employing a complex impedance method. The measurement results are shown in FIG. 10. Note that these compacts contain no binding agent.

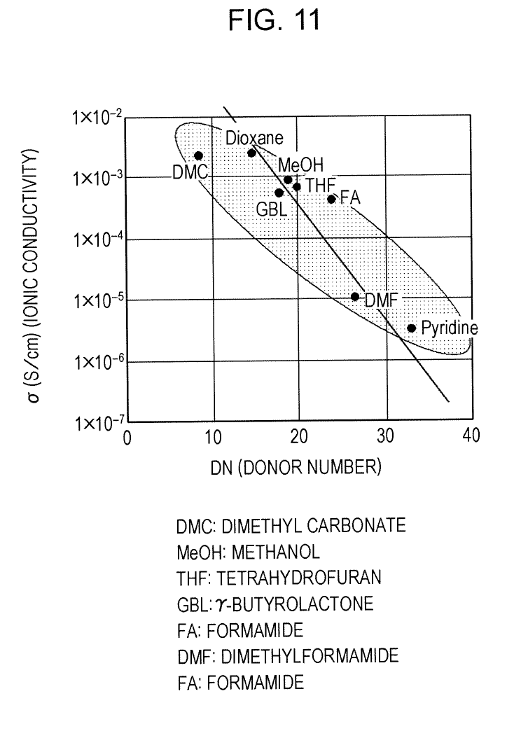

FIG. 11 is a graph illustrating the effect of a solvent on the ionic conductivity in Example of the present invention, the solvent remaining in a compact composed of the pitch material (sulfonated pitch) into which a sulfonic acid group is introduced. In FIG. 11, the horizontal axis represents the donor number (DN) of the solvent, and the vertical axis represents the ionic conductivity (S/cm²) of the compact. The name of the solvent used in preparation of the compact is denoted near each measurement point in the figure.

As shown in FIG. 11, the measurement values of the ionic conductivity σ of the compacts are distributed in an elliptical area. However, except for DMC (dimethyl carbonate), the measurement values are represented by the same approximate straight line σ=−C×DN as that shown in FIG. 9 (Example 1). Similarly to the results shown in FIG. 9 (Example 1), the larger the donor number (DN) of the solvent used, the smaller the ionic conductivity σ of the compact. The ionic conductivities σ of the eight types of solvents used are within a wide range of 3×10⁻⁶ (S/cm²) to 3×10⁻³ (S/cm²). Also from these results, it is believed that the ionic conductivity σ of an electrolyte membrane formed using a solvent having a large donor number (DN) is also low.

The ionic conductivity σ of the compact is not a constant value inherent to the sulfonated pitch used. It is believed that this is because the magnitude of the interaction with the sulfonated pitch varies depending on the type of solvent used for dispersing the sulfonated pitch, and thus the amounts of solvent remaining in the compacts differ.

It is assumed that this effect due to the difference in the interaction between the solvent and the sulfonated pitch is also caused when an electrolyte membrane is formed using a binding agent and the sulfonated pitch as an electrolyte. Thus, it is assumed that a difference in the ionic conductivity of the electrolyte membrane is caused depending on the solvent used in forming the electrolyte membrane.

As described above with reference to FIGS. 9, 10, and 11, the interaction between a proton-conductive composite electrolyte and a solvent can be decreased by using a solvent having a donor number of 8 or more and 25 or less. Accordingly, in the case where a solution in which the proton-conductive composite electrolyte is dispersed and/or dissolved is applied onto a base or a base is impregnated with the solution, and subsequently, the solution is removed by vaporization to form an electrolyte membrane, the amount of solvent remaining in the electrolyte membrane can be decreased, and a proton-conductive composite electrolyte membrane which has high proton conductivity and which is suitable for use in a fuel cell can be obtained. For example, dimethyl carbonate (DMC), dioxane, γ-butyrolactone (GBL), methanol (MeOH), tetrahydrofuran (THF), and formamide (FA) can be suitably used as the solvent having a donor number of 8 or more and 25 or less.

Next, the effect of a solvent used in forming an electrolyte membrane will be described.

(Effect of Solvent Used in Forming Electrolyte Membrane)

### Example 3

Here, the fullerene derivative described above was used as an ion conductor. A description will be made of the effect of a solvent used in forming an electrolyte membrane containing the fullerene derivative. As the solvent, GBL (γ-butyrolactone) was used, and an electrolyte membrane formed using DMF (dimethylformamide) was used as Comparative Example.

The electrolyte membrane was prepared as follows. The fullerene derivative was added to gamma-butyrolactone and was dispersed under stirring for two hours. A PVdF-HFP copolymer (PVdF (90% by mole) and HFP (10% by mole) powder was added to the dispersion liquid as a binding agent so that the content of the binding agent was 30% by weight, and gamma-butyrolactone was added as required. The mixture was stirred at 80° C. for three hours or more to uniformly disperse the fullerene derivative.

The dispersion liquid containing the fullerene derivative and the binding agent obtained in this manner was uniformly spread over a base (glass was used, but a polyimide film, a PET film, a PP film, or the like can also be used) with a doctor blade, and was slowly dried by heating in a clean bench to form a thin film. This thin film was further dried under a reduced pressure at 100° C. for one night. The dry thin film was then detached from the base to obtain an electrolyte membrane.

The thickness of the electrolyte membrane can be controlled in the range of about 3 μm to 50 μm by changing the concentration of the binding agent in the above dispersion liquid (the concentration of the binding agent relative to the solvent, 1% by weight to 30% by weight) and the amount of application per unit area. Note that electrolyte membranes having a thickness of 15 μm were prepared as both this Example and Comparative Example.

The electrolyte membrane used as Comparative Example was similarly prepared by changing the solvent from gamma-butyrolactone to dimethylformamide.

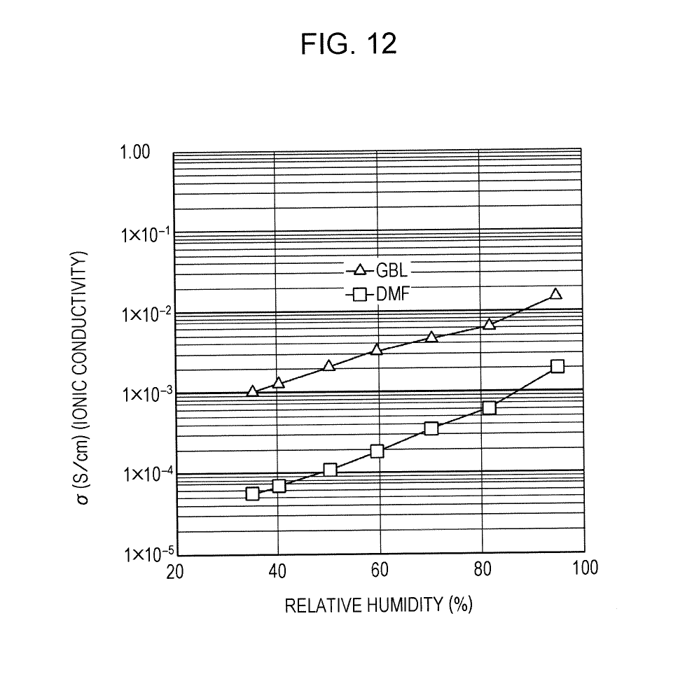

Each of the electrolyte membranes prepared as described above was sandwiched between a pair of gold electrodes by three-point tightening so that the torque was uniform. Thus, measuring cells were prepared. Each of the measuring cells was placed in a constant-temperature, constant-humidity chamber, and ionic conductivity was measured by employing a complex impedance method. The measurement results of the ionic conductivity were obtained after the measuring cell was placed in the constant-temperature, constant-humidity chamber at each humidity and was then allowed to stand for at least about three hours until the impedance data did not change with time. The values thus obtained were adopted as the measurement results of the ionic conductivity. The measurement results are shown in FIG. 12.

FIG. 12 is a graph illustrating the humidity dependence of the ionic conductivity of the electrolyte membrane containing the fullerene derivative in Example of the present invention. In FIG. 12, the horizontal axis represents the relative humidity (%), and the vertical axis represents the ionic conductivity (S/cm²) of the electrolyte membrane. In FIG. 12, the upper curve denoted by open triangles shows the ionic conductivity related to the electrolyte membrane of this Example, and the lower curve denoted by open squares shows the ionic conductivity related to the electrolyte membrane of Comparative Example.

As shown in FIG. 12, it is found that the ionic conductivity of the electrolyte membrane prepared using DMF, which is a solvent having a large donor number of 26.6, significantly decreased over the entire range of the humidity in which the measurement was performed, as compared with the measurement of the ionic conductivity of the electrolyte membrane prepared using GBL, which is a solvent having a small donor number of 18. According to these results, it is assumed that characteristics of fuel cells in which these electrolyte membranes are mounted are significantly different from each other.

Next, a description will be made of characteristics of fuel cells in which the electrolyte membranes of this Example and Comparative Example are mounted, and the effect of the solvents used in forming the electrolyte membranes.

(Characteristics of Fuel Cells and Effect of Solvents Used in Forming Electrolyte Membranes Thereof)

### Example 4

Gas diffusion layers (each having a size of 10 mm×10 mm) on the anode side and the cathode side, the gas diffusion layers being formed by applying catalyst ink onto carbon paper, were assembled on the electrolyte membrane (size: 14 mm×14 mm, thickness 15 μm) of Example 3 at 130° C. for 15 minutes at a pressure of 0.5 kN to form a membrane-electrode assembly (electrolyte membrane-catalyst electrode, MEA). Thus, a fuel cell was fabricated. This fuel cell basically has the same configuration as the above-described direct-type fuel cell illustrated in FIG. 3.

The electrolyte membrane of Comparative Example described above was prepared in the same manner, and a fuel cell of Comparative Example was fabricated.

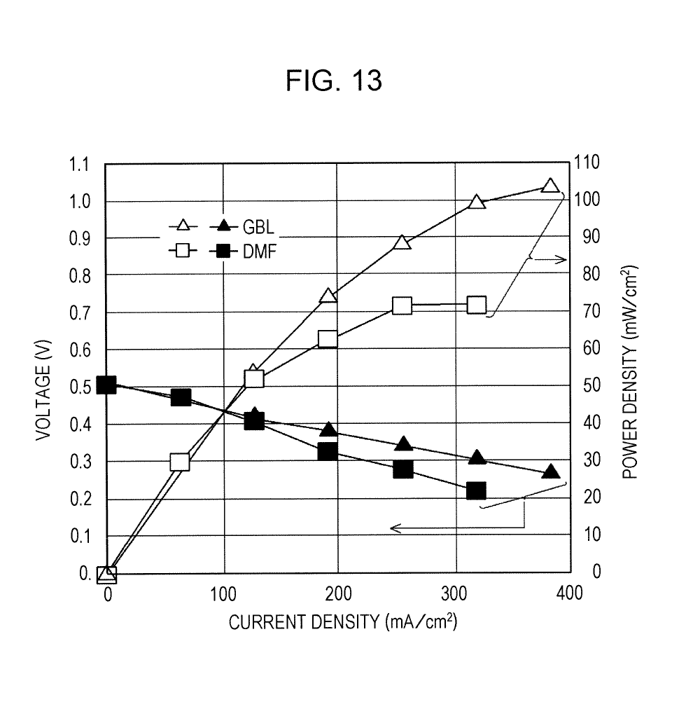

To the gas diffusion layer on the cathode side of each of the fabricated fuel cells, 100% methanol was supplied as a fuel. Air was supplied to the gas diffusion layer on the cathode side thereof by natural aspiration. Characteristics of the fuels cells were measured. The results are shown in FIG. 13.

FIG. 13 is a graph illustrating characteristics of a fuel cell including an electrolyte membrane containing the fullerene derivative in Example of the present invention. In FIG. 13, the horizontal axis represents the current density (mA/cm²), the left vertical axis represents the output voltage (V), and the right vertical axis represents the power density (mW/cm²). In FIG. 13, the upper curves denoted by “open triangles” and “solid triangles” show characteristics related to the fuel cell including the electrolyte membrane of Example 3, and the lower curves denoted by “open squares” and “solid squares” show characteristics related to the fuel cell including the above-described electrolyte membrane of Comparative Example.

As shown in FIG. 13, the cell resistance of the fuel cell in which the electrolyte membrane of Example 3 prepared using GBL, which is a solvent having a small donor number of 18, is mounted significantly changes, as compared with the cell resistance of the fuel cell in which the above-described electrolyte membrane of Comparative Example prepared using DMF, which is a solvent having a large donor number of 26.6, is mounted because of the difference in the ionic conductivity between the electrolyte membranes, and thus the output of the fuel cell is improved.

The output of the fuel cell in which the electrolyte membrane of Example 3 is mounted becomes significantly larger than the output of the fuel cell in which the above-described electrolyte membrane of Comparative Example is mounted with an increase in the current density in a range of more than 100 mA/cm². At a current density of 320 mA/cm², the power density is markedly improved by about 1.4 times.

As described above, the type of solvent used in forming an electrolyte membrane significantly affects the ionic conductivity of the formed electrolyte membrane. Therefore, regarding the type of the solvent, a solvent having a donor number of 25 or less is preferable. By forming an electrolyte membrane using such a solvent, the interaction between the solvent and the electrolyte, which affects the ionic conductivity of the electrolyte membrane, can be suppressed, the ionic conductivity of the electrolyte membrane can be made very high, and a high performance electrochemical device using such an electrolyte membrane can be provided.

Note that, in the above description, by taking a polymer electrolyte which is a fullerene derivative as an example, it has been described that a solvent having a donor number of 25 or less, the solvent having a small interaction with the electrolyte, is used as a solvent used in forming an electrolyte membrane. Similarly, with regard to a solvent used in forming an electrolyte membrane using, as an electrolyte, a proton-conductive composite electrolyte having a Lewis acid group, a solvent having a donor number of 25 or less, the solvent having a small interaction with the proton-conductive composite electrolyte having a Lewis acid group, is used in order to suppress a decrease in the proton conductivity.

The present invention has been described by way of embodiments and Examples. However, the present invention in not limited to the embodiments and Examples described above, and various modifications can be made on the basis of the technical idea of the present invention.

For example, the ion conductor used in forming an electrolyte membrane is not limited to a proton-conductive composite electrolyte having a Lewis acid group, a fullerene derivative, and a sulfonated pitch, and the present invention can be applied to an ion conductor having a cation-dissociative functional group. In addition, the binding agent used in forming an electrolyte membrane is not limited to fluorocarbon resins such as PTFE, PVDF, and a PVdF-HFP copolymer, and other polymeric resins can also be used.

### INDUSTRIAL APPLICABILITY

The present invention can be suitably used in a power-generating device, such as a fuel cell, based on an electrochemical reaction.

### REFERENCE SIGNS LIST

10a to 10d, 12a to 12e: polymer backbone
10e: linking chain
20: anode
22a and 22b: catalyst electrode
23: polymer electrolyte membrane
24a and 24b: gas diffusion layer
25: fuel
26a and 26b: inlet
27a and 27b: passage
28a and 28b: outlet
29a and 29b: exhaust gas
30: cathode
35: air or oxygen
40: membrane-electrode assembly
50: fuel supply portion
60: air or oxygen supply portion

1-16. (canceled)

17. An ion-conductive composite electrolyte comprising:
an electrolyte having an ion-dissociative group; and
a compound having a Lewis acid group,
wherein an electron-accepting atom constituting the Lewis acid group and an electron-donating atom constituting the ion-dissociative group are bonded to each other.

18. The ion-conductive composite electrolyte according to claim 17, wherein the ion-dissociative group is a proton-dissociative group.

19. The ion-conductive composite electrolyte according to claim 18, wherein the compound is a polymer having a plurality of the Lewis acid groups in side chains thereof.

20. The ion-conductive composite electrolyte according to claim 18, wherein the proton-dissociative group is at least one selected from the group consisting of a sulfonic acid group (—SO₃H), a phosphonic group (—PO(OH)₂), a bis-sulfonimide group (—SO₂NHSO₂—), a sulfonamide group (—SO₂NH₂), a carboxyl group (—COOH), a diphosphonomethano group (═C(PO(OH)₂)₂), and a disulfonomethano group (═C(SO₃H)₂).

21. The ion-conductive composite electrolyte according to claim 18, wherein the electron-accepting atom constituting the Lewis acid group is boron (B) or aluminum (Al).

22. The ion-conductive composite electrolyte according to claim 20, wherein the electrolyte is at least one selected from the group consisting of a fullerene compound having the proton-dissociative group, a polymer having, in side chains thereof, a plurality of fullerene compounds each having the proton-dissociative group, a polymer in which a plurality of fullerene compounds each having the proton-dissociative group are linked to each other, and a polymer having a plurality of the proton-dissociative groups in side chains thereof.

23. A membrane-electrode assembly comprising an electrolyte membrane composed of the ion-conductive composite electrolyte according to claim 17, and catalyst electrodes in which a catalyst metal is carried on an electrically conductive carrier, wherein the catalyst electrodes are arranged on both sides of the electrolyte membrane.

24. The membrane-electrode assembly according to claim 23, wherein the catalyst electrodes contain the ion-conductive composite electrolyte.

25. An electrochemical device comprising the membrane-electrode assembly according to claim 23, wherein the electrochemical device is configured so that an ion generated in one of the pair of catalyst electrodes arranged on both sides of the electrolyte membrane is moved to the other catalyst electrode by the electrolyte membrane.

26. The electrochemical device according to claim 25, wherein the electrochemical device is formed as a fuel cell.

27. A method for producing an ion-conductive composite electrolyte membrane, comprising:
a first step of preparing a solution in which an ion-conductive composite electrolyte is at least one of dispersed and dissolved in a solvent having a donor number of 25 or less by adding the ion-conductive composite electrolyte to the solvent;
a second step of applying the solution onto a base or impregnating a base with the solution; and
a third step of removing the solution by vaporization subsequent to the second step.

28. The method for producing an ion-conductive composite electrolyte membrane according to claim 27, wherein, the solvent used in the first step has a donor number of 8 or more.

29. The method for producing an ion-conductive composite electrolyte membrane according to claim 27, wherein the ion-conductive composite electrolyte including:
an electrolyte having an ion-dissociative group; and
a compound having a Lewis acid group,
wherein an electron-accepting atom constituting the Lewis acid group and an electron-donating atom constituting the ion-dissociative group are bonded to each other.

30. The method for producing an ion-conductive composite electrolyte membrane according to claim 27, wherein the ion-conductive composite electrolyte is a proton-conductive composite electrolyte having a proton-dissociative group.

31. The method for producing an ion-conductive composite electrolyte membrane according to claim 27, wherein, in the first step, a polymer binder is added to the solvent together with the ion-conductive composite electrolyte.

32. The method for producing an ion-conductive composite electrolyte membrane according to claim 27, wherein the solvent used in the first step satisfies that a compact formed by using a powder obtained by drying the solvent at 100° C. in a vacuum from a dispersion liquid in which the ion-conductive composite electrolyte is dispersed in the solvent has an ionic conductivity of 1×10⁻⁴ S/cm.
